(19) United States
(12) Patent Application Publication
(10) Pub. No.: US 2025/0141501 A1
(43) Pub. Date: May 1, 2025

(54) SYSTEMS AND METHODS FOR DIMENSIONALITY REDUCTION OF RECIPROCITY-BASED MU-MIMO USING UE EFFECTIVE ANTENNAS

(71) Applicant: Sequans Communications SA, Colombes (FR)

(72) Inventor: Alexander Chiskis, Tel Aviv (IL)

(21) Appl. No.: 18/384,053

(22) Filed: Oct. 26, 2023

(51) Int. Cl. H04B 7/0456; H04B 7/0452

(52) U.S. Cl. CPC H04B 7/0456; H04B 7/0452

(57) ABSTRACT

Disclosed are example embodiments of systems, methods, and devices for enhancing reciprocity-based MU-MIMO performance in a wireless communication system. To incorporate devices with many antenna elements, extend the communication range, and reduce response and adaptation times single and multiple step dimensionality reduction schemes (which may also incorporate interference rejection) are constructed and applied at the UE antenna array. The UE Effective Antennas can be time-variable as well as their number be different from the information layer's number. The schemes parts can have different frequency-time supports and update rates. Methods to deliver from UEs the reduced dimension physical channel matrices to the BS to facilitate the MU-MIMO DL BS precoder construction are disclosed (including different D2A and A2D number cases). BS may optionally facilitate EAs selection. For equal downlink and uplink EAs parts, DL precoder construction may be further assisted via channel reconstruction from decoded uplink data (escaping channel ageing).

### TECHNICAL FIELD

The disclosure relates generally to the field of communication systems, and specifically and not by way of limitation, some embodiments are related to enhanced Multi-User, Multiple-Input, Multiple-Output (MU-MIMO) communication and interference rejection in wireless systems.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple access technologies have been integral to telecommunication standards, enabling wireless devices to communicate across different scales. A notable example is 6G, a successor to 5G New Radio (NR), which represents a continuous evolution in mobile broadband driven by the Third Generation Partnership Project (3GPP). 5G NR addresses emerging requirements for latency, security, scalability (including Internet of Things integration), and other factors. Encompassing services like enhanced mobile broadband (eMBB), massive machine-type communications (mMTC), and ultra-reliable low-latency communications (URLLC), 5G NR builds upon the 4G Long Term Evolution (LTE) standard. As 5G NR advances, there's a recognized need for further enhancements in technology. These advancements have potential relevance to other multi-access technologies and the corresponding telecommunication standards that leverage them.

FIG. 1 is a diagram illustrating a communication system 100 including a gNB 102 (base station) with four antennas 104 and two User Equipment (UE) 106, which also have four antennas 108. Multi-User Multiple-Input Multiple-Output (MU-MIMO) technology has emerged as a one example solution for increasing communication capacity and accommodating a higher number of users within limited resources, such as spectrum bandwidth and time slots. This technology is of particular significance in the context of future wireless communication systems, including 6G, where the density of users is expected to significantly increase, reaching up to 10 users per square meter. A UE 106 may be equipped with multiple antennas 108 that enable communication with base stations (gNB 102) or other users.

While MU-MIMO has been employed in wireline technologies like VDSL and g.fast, where channels are quasi-constant and channel estimation is less challenging, its application in wireless communication faces unique obstacles. The wireless channel is time-variable, and users may possess arrays of antennas with varying numbers of elements. The evolution of antenna arrays is aligned with wavelength reduction trends in current and future wireless standards such as 5G and proposed 6G, necessitating larger numbers of antenna elements to maintain effective area coverage. These arrays can be rigid, flexible, or even printed, reflecting technological advancements.

The challenge arises when dealing with a high number of users equipped with a significant number of antenna elements, e.g., a large number of UE's each having a large number of antennas, leading to a large total number of antenna elements (N_{R}) across all users:

$${N}_{R} ≡ {\sum }_{u = 1}^{{N}_{U}} {N}_{{R}_{( u )}}$$

This poses difficulties for channel estimation and MU-MIMO precoder construction, particularly when the total number of RX antennas (N_{R}) surpasses or greatly exceeds the number of base station (gNB) antennas (N_{T}) and is

$$larger ( {N}_{R} > {N}_{T} )$$

or much larger (N_{R}>>N_{T}) than the number of the base station (gNB) antennas N_{T}.

One issue pertains to interference and the high level of interference noise encountered when transmitting signals to users. Information signals directed to one user act as interference for others, with interference noise levels potentially surpassing ambient noise. Precoding technology is employed to address interference noise, relying on channel knowledge obtained by the Base Station.

Another issue involves the time-intensive process of determining channel matrices that relate UE antennas 108 to base station (gNB) antennas 104, particularly burdensome with a large number of users and antennas. Channel estimation becomes more challenging with multiple RX antennas at UEs, especially if UEs 106 are equipped with an extensive number of antenna elements. This challenge becomes significant when considering varying channels and the firing of Sounding Reference Signals (SRS) signals from each user's physical antennas, demanding substantial time proportional to the total number of antennas 108 on each UE 106.

Yet another issue is the weak back transmission from UEs 106 to the Base Station (gNB 102) for channel estimation purposes. UEs 106 possesses lower transmission power compared to the Base Station (gNB 102), negatively impacting channel estimation quality. This weakness may necessitate multiple close-in-time retransmissions, further exacerbating the time required for channel estimation.

In response to these challenges, a comprehensive approach is proposed that addresses one or more of interference, channel estimation, and transmission power. In some examples, this approach involves dimensionality reduction techniques applied to physical array elements, aiming to create effective antenna arrays at both the UE 106 and Base Station (gNB 102) sides. This approach may offer solutions to the limitations of existing MU-MIMO technology in the context of future high-density wireless communication systems.

### SUMMARY

In one example implementation, an embodiment involves a method that enhances Downlink (DL) channel estimation in a wireless communication system. This approach includes a series of coordinated steps between the gNB (Base Station) and the User Equipment (UE), focusing on optimizing reciprocity-based MU-MIMO performance and facilitating efficient data transmission. By integrating DL and UL signal exchanges, UE Rx EA (Effective Antenna) selection, and DL precoder construction, this embodiment may address the challenges posed by dynamic wireless environments and evolving communication demands. The interaction between gNB-transmitted DL signals, UE-estimated channel responses, UE Rx EA candidates, and UL signals for reciprocity-based estimation creates an efficient communication framework, emphasizing signal quality, interference management, and system performance.

Disclosed are example embodiments of a method for enhancing Downlink (DL) Reciprocity-based MU-MIMO performance in a wireless communication system. The method also includes the steps of specifying at least one UE Rx EA (Effective Antenna) candidate and transmitting UL signals from the UE to facilitate reciprocity-based DL channel estimation by a base station, wherein the transmission is carried out via said specified at least one UE Rx EA. The method includes the steps of estimating a DL channel response at the base station using UL reciprocity and selecting at least one of said specified UE Rx EA candidates for DL reception. Additionally, the method includes constructing a DL precoder at the base station based on said estimated DL channel response and the selected UE Rx EA(s), and decoding DL transmission data at the UE using at least one of said specified UE Rx EA(s).

Disclosed are example embodiments of a method for enhancing Downlink (DL) Reciprocity-based MU-MIMO performance, performed by a base station. The method includes the steps of receiving UL signals from the UE for reciprocity-based DL channel estimation, wherein the UL signals are transmitted by the UE via specified UE Rx EA (Effective Antenna) candidates and estimating the DL channel response based on the received UL signals using UL reciprocity. Additionally, the method includes selecting at least one UE Rx EA candidate specified by the UE for DL reception based on the estimated DL channel response and constructing a DL precoder based on the estimated DL channel response and the selected UE Rx EA(s). Additionally, the method includes transmitting DL transmission data to the UE using the DL precoder.

Disclosed are example embodiments of a base station created to enhance reciprocity-based MU-MIMO performance in a wireless communication system, The base station includes a base station processing unit and a memory unit that stores instructions for the base station's operations. The instructions cause the base station to estimate the DL channel response based on received UL signals in order to construct a DL precoder, while a memory unit stores instructions for the base station's operations and configure its precoder for MU-MIMO operation and transmit data encoded using said precoder. The base station processing unit further includes a control unit that oversees the device's operations to enhance reciprocity-based MU-MIMO performance.

Disclosed are example embodiments of a User Equipment (UE) device for enhancing Downlink (DL) Reciprocity-based MU-MIMO performance in a wireless communication system. The UE includes a communication interface configured to receive DL signals from a base station to facilitate DL Reciprocity-based MU-MIMO performance improvement and a memory unit configured to store instructions. When the instructions are executed by a processing unit, the instructions cause the UE device to specify at least one UE Rx EA (Effective Antenna) candidate and transmit UL signals to facilitate reciprocity-based DL channel estimation by the base station, wherein the transmission is performed via the UE Rx EA candidates. Additionally, when the instructions are executed by a processing unit, the instructions cause the UE device to select at least one UE Rx EA candidate for DL decoding and decode DL transmission data using the selected UE Rx EA(s). The UE further includes a control unit configured to control operations of the communication interface, processing unit, and memory unit according to the instructions stored in the memory unit, and wherein the UE device is adapted to perform operations to enhance Reciprocity-based MU-MIMO performance in the wireless communication system.

Disclosed are example embodiments of a method for enhancing Downlink (DL) Reciprocity-based MU-MIMO performance in a User Equipment (UE). The method includes the steps of specifying at least one UE Rx EA (Effective Antenna) candidate and transmitting UL signals from the UE to facilitate reciprocity-based DL channel estimation by a base station, wherein the transmission is carried out via said specified at least one UE Rx EA. The method includes select at least one UE Rx EA candidate for DL decoding and decoding DL transmission data at the UE using the selected UE Rx EA(s).

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram illustrating a gNB (base station) with four antennas and two UE, which also have four antennas.

FIG. 2 is a diagram illustrating a system block diagram of a communications system.

FIG. 3 is a diagram illustrating the UE RX Effective Antenna concept.

FIG. 4 is a diagram illustrating an SRS back transmission via Effective Antennas from an Effective Antenna with an index “n.”

FIG. 5 is a diagram illustrating an option of the usage.

FIG. 6 is a diagram illustrating an example of possible allocations of the “fine” G₍ᵤ₎⁽¹⁾ and of the “rough” G₍ᵤ₎⁽²⁾ matrices along the frequency axis despite the regular allocation is shown, we stress that the allocation can also be not regular and channel adaptive.

FIG. 7A is a diagram illustrating the design option, G₍ᵤ₎⁽¹⁾ can be digital matrix, and G₍ᵤ₎⁽²⁾ can be the analog matrix.

FIG. 7B. illustrating a two-step processing for the mixed architecture arrays having analog and digital hardware elements.

FIGS. 8A-8C are diagrams illustrating multi-step dimensionality reduction.

FIGS. 9 and 10 illustrate SRS transmission with smaller number of DAC (e.g., than the number of ADC).

FIG. 11 is a diagram illustrating a UE with enhancing DL Channel Estimation.

FIG. 12 is a diagram illustrating a base station (gNB) with Enhancing DL Channel Estimation.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Disclosed herein are example embodiments of systems, methods, and devices for enhancing Reciprocity-based MU-MIMO performance in a wireless communication system. In some embodiments, to incorporate devices with a large number of antenna elements (notably when the aggregate count of UE device RX antennas surpasses the quantity of base station TX antennas), to evade UE RX antenna contamination from multi-user interference, to amplify the communication range with UEs in the MU-MIMO mode, and to diminish response and adaptation durations: dimensionality reduction may be enacted at the UE's antenna array.

In certain embodiments, a methodology is introduced wherein UEs convey the dimension-reduced physical channel matrices to the base station, facilitating the construction of the DL base station precoder for MU-MIMO operations. In some scenarios, various schemes of dimensionality reduction are detailed, encompassing both single-stage and multi-stage reduction processes, along with potential architectures of these reductions.

Furthermore, in some embodiments, methods to communicate a comprehensive set of UE RX EAs, especially when the count of D2A (digital to analog transformers purposed for transmission) is less than the count of A2D (analog to digital transformers intended for reception) are elucidated. In another embodiment, the incorporation of interference cancellation into the dimensionality reduction schema is detailed. Numerous schemes of EA constructions considering interference cancellation are presented. Some of these schemes might feature an EA count unintentionally surpassing the number of information layers. Additionally, there's a showcase of a prospective further dimensionality reduction from such schemes into lower-dimension systems.

In various embodiments, the quantity of effective antennas epitomizing dimensionality might vary amongst users participating in MU-MIMO and could be either less, equivalent, or greater than the information layer count for these users. It may also fluctuate over time. The supports (spanning frequency and time) may diverge for distinct phases of dimensionality reduction.

The collection of UE RX EAs might be transmitted to the BS through SRS transmission in certain scenarios. This assortment can represent the set actively utilized by the UE or an expanded set, enabling the BS to optionally cherry-pick candidates and send them back to the UE efficaciously.

For illustration, a method might encompass transmitting DL signals from a base station, determining the DL channel response, designating UE Rx EA candidates predicated on the determined DL channel response, and dispatching UL signals from the UE to amplify reciprocity-based MU-MIMO performance. Another method might involve inferring the DL channel response employing UL reciprocity and pinpointing a subset of UE Rx EA candidates for DL transmission.

In a distinct embodiment, UE TX EAs (pertaining to the uplink) form components of the UE RX EAs (related to the downlink). For shared portions of DL and UL effective antennas, the EA channels might be discerned by the base station from the UE's uplink data, authorizing the base station to employ the freshest channel knowledge in the assembly of the DL precoder. This strategy might be viable for pilotless schemes, seen as prospective candidates for 6G technology.

For cases involving copious antenna elements at the base station, an auxiliary set of base station TX EAs may be formed through amalgamation. While these are available for utilization as genuine base station TX EAs, they aren't necessarily harnessed for subsequent broadcasts. A user equipment (UE) might employ transmissions from the aforementioned set to develop UE RX EAs, with the construction rooted in the physical channel matrix associated with the supplementary base station TX EAs. This matrix might be optionally adjusted by the UE to reject interference.

Embodiments of the systems, methods, and devices described herein may have one or more of the following capabilities. For example, one embodiment of the systems, methods, and devices described herein may include enhancing MU-MIMO performance in a wireless communication system.

Precoding may be used as a tool to remove or relax the interference. To solve or relax the problem of the interference noise a precoding technology may be used. The base station may prepare its transmission toward users in such a way to eliminate or diminish the interference.

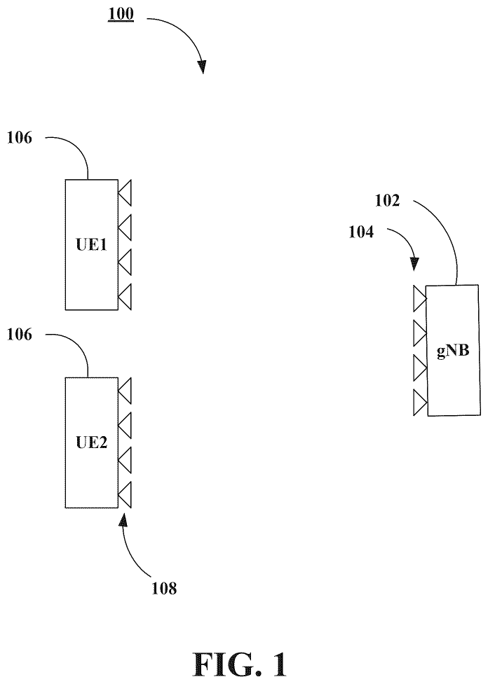

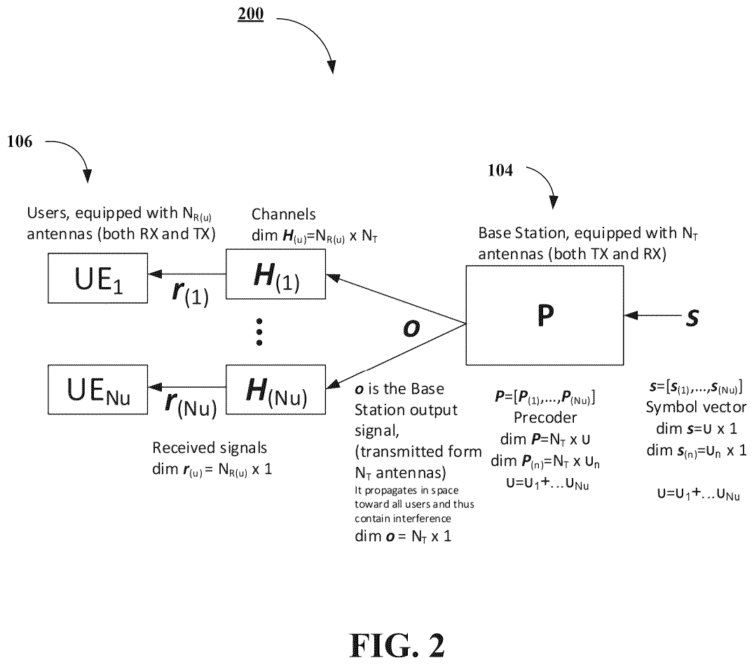

FIG. 2 is a diagram illustrating a system block diagram of a communications system 200. The Base Station (gNB 102) mixes the information streams via precoder matrix, P, in such a way that upon arriving over physical channel toward users' antennas the signals become un-mixed. This illustrative example presents the zero-forcing (ZF) design. For example, for UEs 106 having each antenna (e.g., antennas 108 of FIG. 1) (hence one layer per user is transmitted), the precoding eliminating the interference is well known:

$$P = p i n v ( H ) * D = {{H}^{H} ( H {H}^{H} )}^{- 1} * D$$

Here the matrix dimensions are:

$$dim H = {N}_{U} \times {N}_{T} , dim D = {N}_{U} \times {N}_{U} , dim P = {N}_{T} \times {N}_{U} , {N}_{U} \leq {N}_{T}$$

where N_{U} is the number of users, N_{T} is the number of the base station (gNB 102) TX antennas. The diagonal matrix D adjusts the TX powers toward users. In the above relation the individual channels of all users are stacked horizontally into the total channel matrix:

$$H = [ \begin{matrix}{H}_{( 1 )} \\ ⋮ \\ {H}_{( {N}_{U} )}\end{matrix} ]$$

FOR the channels equipped with 1 RX antenna, the above H₍ₙ₎ matrices are row vectors of equal dimension: 1×N_{T}. This relation can be readily proved as:

$$r = H * Ps + n = H * pinv ( H ) * Ds + n = H * {{H}^{H} ( {HH}^{H} )}^{- 1} * Ds + n = Ds + n$$

For 1-antenna devices, the received vectors, the corresponding symbols and the ambient noise on their antennas are combined in vectors having the following dimensions:

$$dim r = dim s = dim n = {N}_{U} \times 1$$

Since matrix D is diagonal, there is no inter-user interference.

Let us now discuss the situation when number of users is smaller than the number of base station (gNB 102) TX antennas N_{U}≤N_{T} but the total number of the RX antennas N_{R}≡Σᵤ₌₁^{N}^{_{U}}N_{R}_{₍ᵤ₎} is larger than the number of the TX antennas of the base station (gNB 102):

N_{R}>N_{T}

To resolve this problem, a projection method referred to as “Coordinated Transmit-Receive Processing.” It will be referred to as the “Effective Antenna approach,” herein. The Effective Antenna approach may be illustrated by considering a single layer transmission to all users. Every user u=1: N_{U} is equipped with N_{R}_{₍ᵤ₎} RX antennas and it treats its received signal vector r₍ᵤ₎

$$dim {r}_{( u )} = {N}_{{R}_{( u )}} \times 1$$

with an “equalizer” row vector w₍ᵤ₎^{H}

$$dim {w}_{( u )}^{H} = 1 \times {N}_{{R}_{( u )}}$$

as w₍ᵤ₎^{H}H₍ᵤ₎. The output of this projection is 1-layer scalar reduced dimension signal:

$${\overline{r}}_{( u )} = {w}_{( u )}^{H} * {r}_{( u )}$$

The equation for the 1-layer scalar reduced dimension signal is:

$${\overline{r}}_{( u )} = {w}_{( u )}^{H} {r}_{( u )} = {w}_{( u )}^{H} {H}_{( u )} Ps + {n}_{( u )}$$

Then the base station may construct the zero-forcing solution from the modified channel:

$$\overline{H} = [ \begin{matrix}{w}_{( 1 )}^{H} {H}_{( 1 )} \\ ⋮ \\ {w}_{( {N}_{U} )}^{H} {H}_{( {N}_{U} )}\end{matrix} ] ,$$

$$dim \overline{H} = {N}_{U} \times {N}_{T} ,$$

$$dim {w}_{( u )}^{H} {H}_{( u )} = 1 \times {N}_{T}$$

The precoder for that single-layer transmission is then given as:

$$P = pinv ( \overline{H} ) * D$$

Note: the inter-user-interference is present on the UE RX antennas, but it is cleaned out for the specific linear combination: w₍ᵤ₎^{H}r₍ᵤ₎ for every user.

The base station possesses knowledge regarding the combinations of w₍ᵤ₎^{H}H₍ᵤ₎, which constitute the matrix H̅. This knowledge is distinct from any known art. Accordingly, this particular aspect is included as a component in some embodiments of the systems and methods described herein.

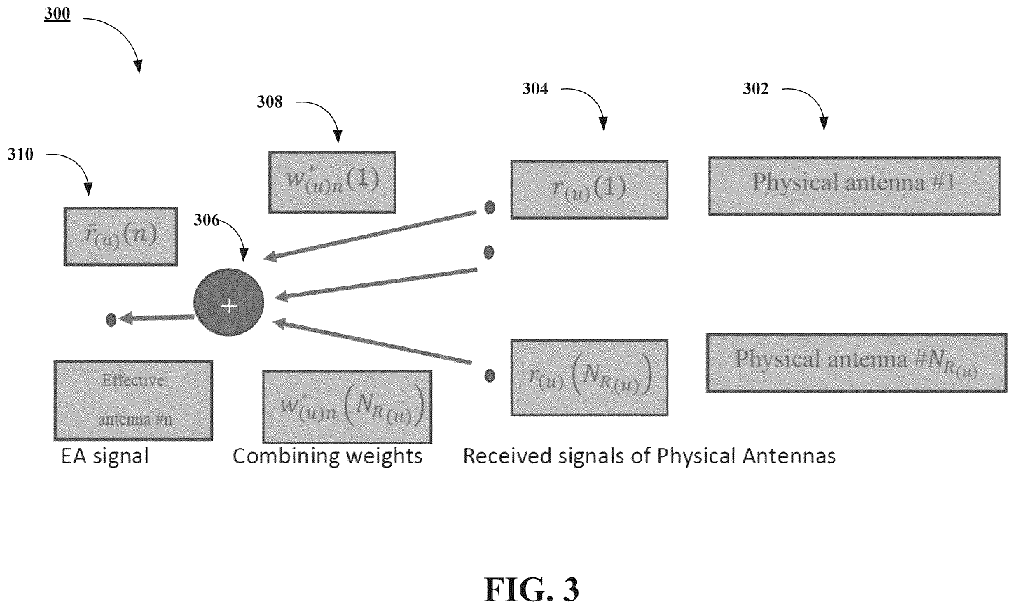

FIG. 3 is a diagram 300 illustrating the UE RX Effective Antenna concept (which we will often abbreviate as UE RX EA(s), where “s” stays for optionally several Effective Antennas). Diagram 300 includes a series of physical antennas 302, e.g., physical antenna 1 to physical antenna N_{R}_{₍ᵤ₎}. The physical antennas 302 may output receive signals 304, e.g., indicated by r₍ᵤ₎(1) to r₍ᵤ₎ (N_{R}_{₍ᵤ₎}). The signals 304 may be combined 306, with each multiplied by combining weights 308, e.g., w₍ᵤ₎ₙ*(1) to w₍ᵤ₎ₙ*(N_{R}_{₍ᵤ₎}) to form the effective antenna signal 310, e.g., r̅₍ᵤ₎(n). (Here n is the index of the effective antenna of specific user u. As we explain below, there could be several effective antennas and their total number for user u is N̅_{R}_{₍ᵤ₎}).

The UEs Rx effective antennas are defined below. Effective RX or TX antenna means a set of linear combinations over RX or TX array. “Effective” objects are denoted by a bar over a letter. For the RX array of size N_{R(u)} a weighted combination of the received signals r₍ᵤ₎ is:

$${\overline{r}}_{( u )} ( n ) = weighted\_combination = {w}_{( u ) n}^{H} {r}_{( u )} , dim {w}_{( u ) n} = dim {r}_{( u )} = {N}_{{R}_{( u )}} \times 1$$

The components of the received signal vector originating from the complete set of RX antennas are merged into a complex-valued scalar. This merging process is analogous to establishing a solitary effective RX antenna. Within this context, the variable n designates the index corresponding to a particular weight row vector, or “equalizer.” Each specific amalgamation defines what is termed an Effective Antenna (EA). Consequently, solely these effective antennas, and not the entirety of physical antennas, will remain unaffected by interference, constituting the target for the Downlink (DL) precoder.

The total N̅_{R}_{₍ᵤ₎} rows of the equalizer vectors can be stacked into an equalizer matrix G₍ᵤ₎

$${G}_{( u )} = [ \begin{matrix}{w}_{( u ) 1}^{H} \\ ⋮ \\ {w}_{( u ) {\overline{N}}_{{R}_{( u )}}}^{H}\end{matrix} ]$$

Then, it can be observed that:

$${\overline{r}}_{( u )} = {G}_{( u )} * {r}_{( u )} ,$$

$$dim {G}_{( u )} = {\overline{N}}_{{R}_{( u )}} \times {N}_{{R}_{( u )}} ,$$

$$dim {\overline{r}}_{( u )} = {\overline{N}}_{{R}_{( u )}} \times 1$$

The effective antennas shrink the full channel represented by the channel matrix H₍ᵤ₎ with N_{R(u)} rows (each having length of N_{T}) and of dimension dim H₍ᵤ₎=N_{R}_{₍ᵤ₎}×N_{T}, into the transformed channel with reduced number of N̅_{R}_{₍ᵤ₎}:

$${\overline{H}}_{( u )} = {G}_{( u )} * {H}_{( u )} ,$$

$$dim {\overline{H}}_{( u )} = {\overline{N}}_{{R}_{( u )}} \times {N}_{T} ,$$

Each of its rows represents channel of UE RX effective antenna (EA) (this is a row vector of length N_{T} representing channels from base station antennas to the EA):

$${h}_{( u ) n}^{H} ≡ {\overline{H}}_{( u )} ( n , 1 : {N}_{T} ) = {w}_{( u ) n}^{H} {H}_{( u )} ,$$

$$n = 1 : {\overline{N}}_{{R}_{( u )}} ,$$

$$dim {h}_{( u ) n}^{H} = 1 \times {N}_{T}$$

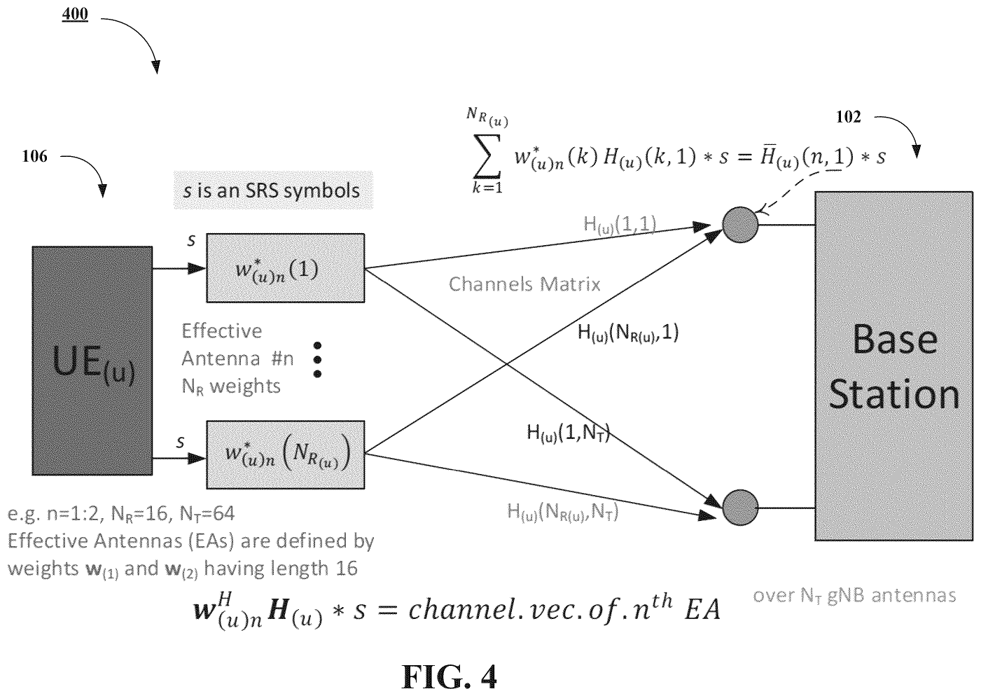

FIG. 4 is a diagram illustrating an SRS back transmission from an effective antenna with an index “n” 400. The diagram illustrates base station 102 in communication with UE (u) 106. The SRS back transmission of the transformed channel may be via Effective RX antennas. Multiple UEs have the option to deliver the “equalizer” matrix to the base station (gNB) 102. A potential definition of the “equalizer” matrix per RE might result in a considerable amount of information, which could be overly extensive if pursued digitally. Certain approaches suggest an “analog” solution involving SRS back transmission. To formulate the DL precoder, the base station (gNB) doesn't necessarily require the complete (and large) channel matrix H₍ᵤ₎, but rather the modified channel H̅₍ᵤ₎ can be derived by assembling the rows: h₍ᵤ₎ₙ^{H}.

The downlink precoder (at the Base Station 102) may be constructed from the effective users' channels. The effective cannel matrix H̅₍ᵤ₎ may have reduced dimensions (in the number of the UE RX antennas, which is the number of rows) about the actual channel H₍ᵤ₎.

Some embodiments may use reference signals (RS). Reference signals are primarily used for channel estimation. The reference signal may help the receiver to estimate the channel through which the signal has passed and thus make necessary adjustments for decoding. The reference signal may also be used for synchronization between the transmitter and receiver and to assist with beam management, feedback, demodulation, and other tasks. Reference signals may include known sequences or patterns that a receiver may be aware of. Because the receiver knows what to expect, the receiver can compare the received reference signal to the expected pattern to determine how the channel might have distorted the signal. A reference signal may be sent over specific frequency tones (known as pilots) or spread across an entire symbol. The transmission of these signals isn't continuous but occurs periodically or on-demand, based on system needs.

In an example embodiment the Sounding Reference Signal (SRS) may be transmitted back to the Base Station by using exactly the same weights which create the effective channel. This follows from the superposition principle for linear systems. This may be proved by transmitting the SRS from the UE 106 (user u) k-th physical antenna produces onto the array of the base station 102 signals given by the k-th row of the full matrix channel containing N_{T} elements:

$$[ {H}_{( u )} ( k , 1 ) , … , {H}_{( u )} ( k , {N}_{T} ) ] * s ,$$

where s is the known symbol of the SRS. Then, the signal from the EA with index “n” imprints on N_{T} the base station (gNB) antennas 104 the weighted superposition from every k=1:N_{R(u)}. The weights are w₍ᵤ₎ₙ*(k). Then, it can be observed that this delivers to the base station (gNB) 102 the needed effective channel row corresponding to the EA with index “n”. Furthermore, it can be observed that this approach provides the necessary effective channel row corresponding to the EA indexed as “n” to the base station (gNB) 102:

$${\sum }_{k = 1}^{{N}_{{R}_{( u )}}} {w}_{( u ) n}^{*} ( k ) * [ {H}_{( u )} ( k , 1 ) , … , {H}_{( u )} ( k , {N}_{T} ) ] * s = {w}_{( u ) n}^{H} {H}_{( u )} * s ≡ {\overline{H}}_{( u )} ( n , 1 : {N}_{T} ) * s$$

It may be assumed that the same antennas are used for reception (RX) and transmission (TX) at UE 106 and at base station 102 (see remark below on how to generalize it). The full effective channel H̅₍ᵤ₎ may be delivered via SRS from effective antennas in any form known (e.g., via SRS transmissions separated in time).

In exemplary embodiments, the Base Station's N_{T} antennas exhibit a range of configurations, including physical and effective antenna setups. It is emphasized that this dichotomy in antenna types does not impede the generality of the innovative concept disclosed herein.

Illustrating the versatility of the proposed approach, a broader application context is considered. Within this context, it is postulated that the simultaneous utilization of all receiving (RX) antennas for transmission might not be feasible. Instead, a subset of RX antennas, constituting a diminished count, can be strategically employed. This subset is formed by segregating the set of antenna indices into distinct sub-groups.

Transmission activities are facilitated by applying corresponding weights to each subset of antennas. Importantly, these transmissions transpire at distinct temporal intervals or on discrete Resource Element (RE) frequencies, ensuring separation. Subsequent to transmission, the Base Station employs an aggregation process wherein signals from all these transmissions are meticulously combined across every individual antenna of the Base Station.

It is to be expressly noted that the successful implementation of such transmissions necessitates rigorous coordination at the system level. This coordination effort is imperative to achieve optimal synergy among the various transmission components and ensure seamless operation within the proposed framework.

In some example embodiments, the use of EAs (we will employ this abbreviation for Effective Antennas) yields a range of advantages. Effective Antennas enable broader participation of users in MU-MIMO scenarios, especially when UE is equipped with multiple physical antennas. EAs contribute to a reduction in the time required for SRS back transmissions, a central aspect of the innovation described in this patent. This reduction is particularly valuable during update modes, where static weights and changing channel conditions necessitate swift formulation of new precoders by the base station (gNB).

Efficient use of EAs may mitigate the transmission overhead associated with sending signals from each individual physical Receiving (RX) antenna within a large array, especially in scenarios involving multiple participating UEs in MU-MIMO. The combined weights of EAs also function as an array gain mechanism, particularly effective when these weights are strategically selected to optimize SU-MIMO transmissions tailored for specific users (u). This optimization addresses the challenge of weak signals from individual antennas. The benefits derived from EAs extend the operational range of MU-MIMO within the Time Division Duplex (TDD) reciprocity mode, potentially accommodating a larger number of operational User Equipment (UE) within the designated operational field. Optimizing the SU-MIMO process, conducted on a per-Resource Element (RE) basis, involves integrating Effective Antennas (EAs). This may involve constructing user (u)'s SU-MIMO configuration using well-suited hermitically conjugated vectors, specifically referred to as u₍ᵤ₎ₘ vectors. The mentioned SU-MIMO may be optimized (per RE) with e.g., EAs for user (u) to be constructed from the best (hermitically conjugated) u₍ᵤ₎ₘ vectors, namely as:

$${w}_{( u ) n}^{H} = {u}_{( u ) n}^{H}$$

of the SVD decomposition of the full physical channel H₍ᵤ₎=Σₘ₌₁^{min(N}^{_{R(u)}}^{N}^{_{T)}} σ₍ᵤ₎ₘu₍ᵤ₎ₘv₍ᵤ₎ₘ^{H} (hence the effective channel rows will be the v₍ᵤ₎ₘ^{H}-vectors) and the gains may be the largest possible to extract from the channel: h₍ᵤ₎ₙ^{H}=H̅₍ᵤ₎ (n, 1: N_{T})=σₘvₘ^{H}. This is SU-MIMO heuristic way, since it ignores the other users.

A multi-step approach to EAs construction may be used in some embodiments. The matrix G₍ᵤ₎ may have a fine structure. The matrix G₍ᵤ₎ may be different for different users (hence index u dependent). Every matrix may belong to possibly different (finite-size or infinite-size/continuous) “alphabet” sets:

$${G}_{( u )} = {\prod }_{n = 1}^{{N}_{{G}_{( u )}}} {G}_{( u )}^{( n )}$$

where the matrices G₍ᵤ₎⁽ⁿ⁾ perform dimensionality reduction in total N_{G}_{₍ᵤ₎} steps. The steps may be defined per different support and may be updated with different frequency.

F.E. two-step dimensionality reduction:

$${G}_{( u )} = {G}_{( u )}^{( 1 )} {G}_{( u )}^{( 2 )}$$

$$dim {G}_{( u )}^{( 1 )} = {\overline{N}}_{{R}_{( u )}} \times {N}_{( u )}^{( dim - reduction 2 )} ,$$

$$dim {G}_{( u )}^{( 2 )} = {N}_{( u )}^{( dim - reduction 2 )} \times {N}_{{R}_{( u )}}$$

The outer element, performing the larger dimensionality reduction may be updated less frequently. Even if the channel (slightly) changes, they still focus the power onto the effective antennas, thus performing more precise channel estimation. In the relation G₍ᵤ₎=G₍ᵤ₎⁽¹⁾G₍ᵤ₎⁽²⁾ the matrix G₍ᵤ₎⁽²⁾ is updated less frequently and G₍ᵤ₎⁽¹⁾ more frequently. Keeping G₍ᵤ₎⁽¹⁾, which may be adjusted according to the changing channel H₍ᵤ₎, to allow the exact ZF be performed. Better effective channel estimation accuracy allows faster channel acquisition (without repetitions, or with smaller number of them).

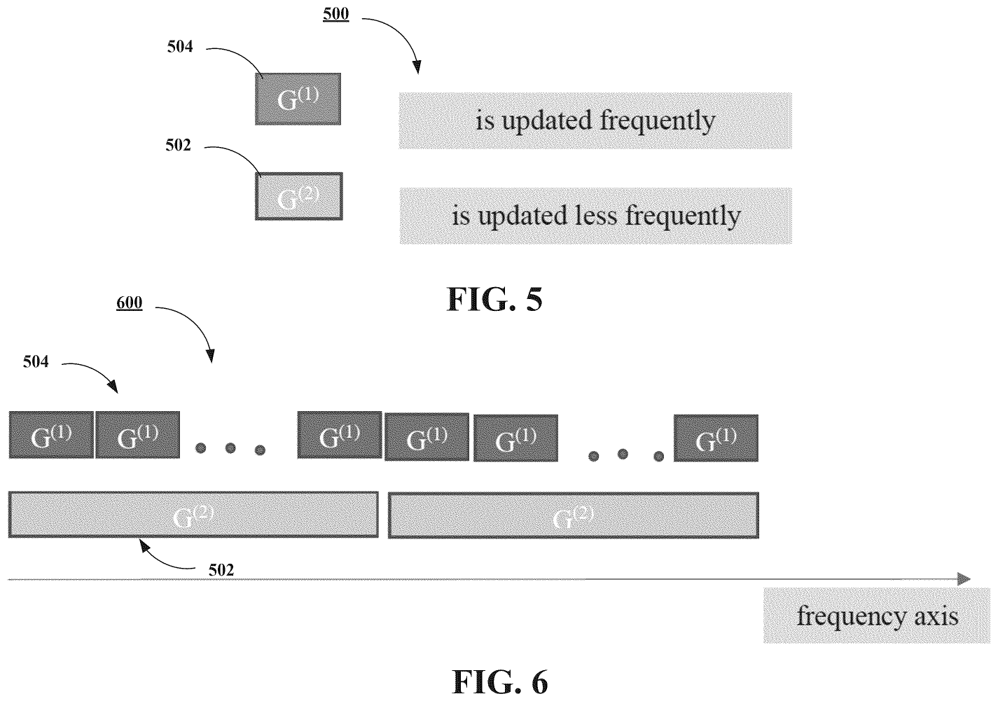

FIG. 5 is a diagram illustrating an option of the usage 500. In the example usage 500, the larger matrix 502 may be updated less frequently than the smaller matrix 504. The fine structure matrix G₍ᵤ₎⁽¹⁾ can be fixed per smaller-size sets of RE (e.g., per RE) and the “rough” matrix G₍ᵤ₎⁽²⁾ can be defined per larger sets of RE (e.g., per sub-band, or per whole frequency band: this division can also be channel dependent).

FIG. 6 is a diagram illustrating an example of possible allocations 600 of the “fine” G₍ᵤ₎⁽¹⁾ and of the “rough” G₍ᵤ₎⁽²⁾ matrices along the frequency axis. The matrix has the same fixed values insight of the boxes. The box-size for the G₍ᵤ₎⁽¹⁾ may be 1 RE (or somehow larger if the channel changes very slowly over the frequency axis). The sizes of the sets at all levels of the dimensionality reduction can be regular (identical, as in FIG. 6) or variable (according to the channel variability). The fine structure matrix G₍ᵤ₎⁽¹⁾ can be digital matrix, and the “rough” matrix, G₍ᵤ₎⁽²⁾ can also be digital but also it can be the analog matrix (hence within a finite-size alphabet). Such structure can perform dimensionality reduction of a large array to N̅_{R(u)} effective antennas.

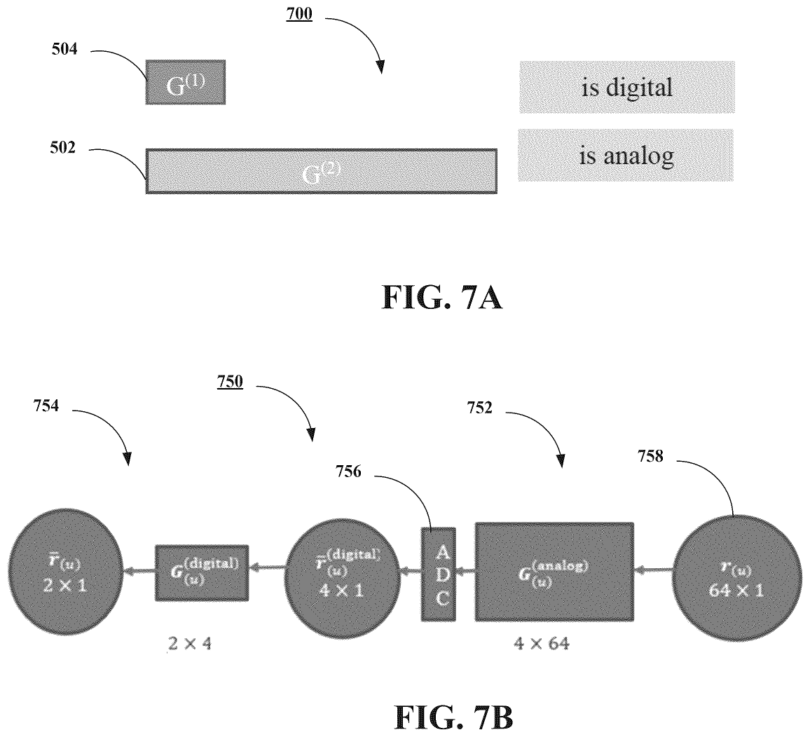

FIG. 7A is a diagram 700 illustrating the design option, G₍ᵤ₎⁽¹⁾ 504 may be a digital matrix, and G₍ᵤ₎⁽²⁾ 502 may be the analog matrix. An illustrative example, the sizes can be:

$${\overline{N}}_{{R}_{( u )}} = 2 ,$$

$${N}_{( u )}^{( dim - reduction 2 )} = 4 ,$$

$${N}_{{R}_{( u )}} = 64$$

FIG. 7B. illustrating a block diagram 600 of a two-step processing for the mixed architecture arrays having analog hardware elements 752 and digital hardware elements 754. In FIG. 7B, four analog-to-digital converters (ADCs) 756 are illustrated, e.g., as a single block. The mixed analog and digital architecture saves the ADC converters 756 by not requiring them to be attached to every array element 758 and may make the array 758 cost effective and simpler. The weights (for analog parts) are typically from pre-defined sets of possible phasors where the phase shifts of the incoming signals are done effectively by analog components. The array may be presented as an array with 64 RX antennas 758 and having four cADC 756 (complex-valued ADC). FIG. 7B. Illustration of the two-step processing for the mixed architecture arrays having analog and then digital hardware elements.

The decomposition may reduce 64 (e.g., small) physical antennas toward 2 effective antennas in two steps. The final two effective antennas may serve two or one information layers (we also note that they may also serve more information layers if an overloaded MIMO is used).

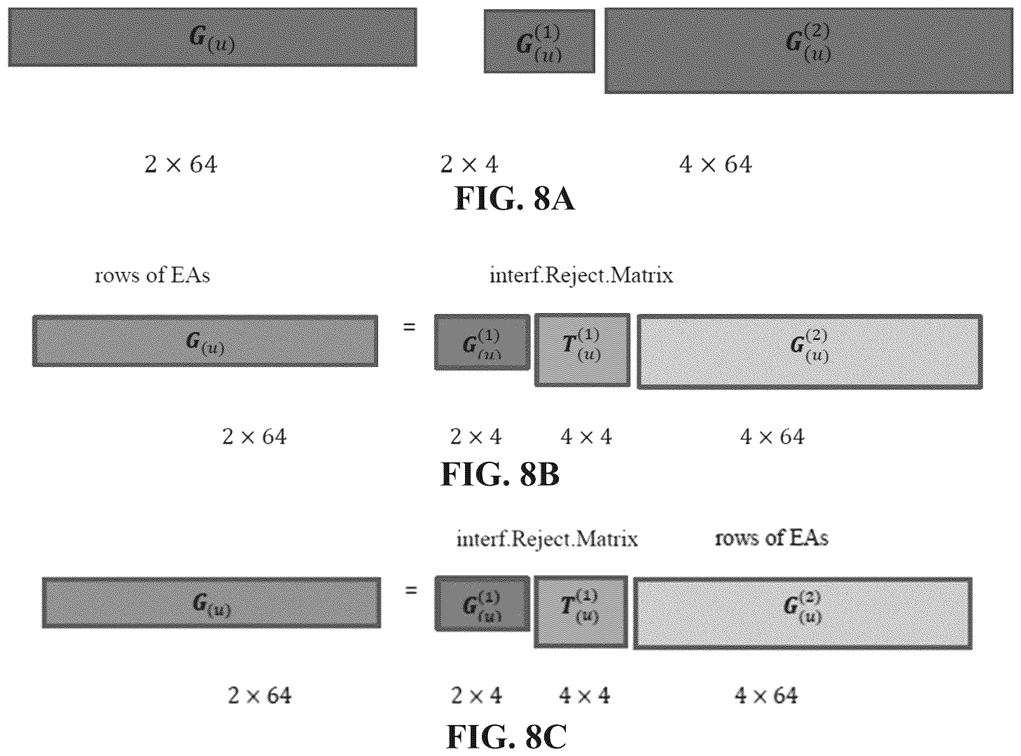

FIGS. 8A-8C are diagrams illustrating example matrix sizes. FIG. 8A illustrates example matrix sizes for G₍ᵤ₎ (2×64), G₍ᵤ₎⁽¹⁾ (2×4), and G₍ᵤ₎⁽²⁾ (4×64). FIG. 8B illustrates example matrix sizes for G₍ᵤ₎ (2×64), G₍ᵤ₎⁽¹⁾ (2×4), T₍ᵤ₎⁽¹⁾ (4×4), and G₍ᵤ₎⁽²⁾ (4×64). It will be understood that these are only examples and other matrix sizes are possible. It should be noted that in some implementations, the G₍ᵤ₎⁽ⁿ⁾ matrices may include a mix of analog stages and digital stages.

FIG. 8C illustrates an example of interference rejection at the intermediate dimensionality reduction stage. Here, G₍ᵤ₎⁽²⁾ rows (total of 4 rows in this example) may be used as Effective Antennas (EAs). The stages following the EAs represent the interference rejection and information signal/s processing, which happens after EAs. For clarity, G₍ᵤ₎⁽¹⁾ and T₍ᵤ₎⁽¹⁾ are shown separately (and may also be combined together as a single 2×4 matrix). The goal is to improve signal quality. One technique used for the interference rejection is spatial filtering, which focuses on receiving the desired signal and reducing disruptions from other sources. Other interference mitigation techniques can also be used depending on the interference scenario.

EAs suggestion from base station (gNB):

UE does not know the EAs of the other users. Hence, a suggestion from the base station (gNB) can be welcomed. E.g., part of EAs effective channel of different users can be (highly) correlative, and suggestions can moderate that.

As a further ramification of the EAs approach, every UE can specify and suggest to base station (gNB) an enlarged “EAs candidates set”, and base station (gNB) may select a subset of these candidates by returning a binary string (for every UE) in which ones may indicate which EAs are to use. The candidates may be specified by the UE (and further refined) based on at least one of: the estimated DL channel response, or the information communicated from gNB (the indication from gNB for all or part of the equalizer chain elements e.g., for G₍ᵤ₎⁽²⁾ while G₍ᵤ₎⁽¹⁾ can be then determined from the effective channel the UE observes after G₍ᵤ₎⁽²⁾, namely on the channel H₍ᵤ₎⁽²⁾=G₍ᵤ₎⁽²⁾H₍ᵤ₎ e.g., by means of the SVD of this reduced-size channel as we will explain (u) further), or from the past accumulated information/knowledge at UE, or a random selection, or a predefined selection. The gNB may select a subset from the specified UE EAs to be used for DL reception. The gNB, when selecting the candidates may look at the prediction of the performance of the ensemble of users. Hence, by selecting the EAs from the list of possibles (for every user), gNB optimizes a Cost Function.

### Among Possible Criteria:

### Communication Related Criteria

In these examples optimization is performed at the network level, i.e., across multiple DL links. Rates_vec holds the vector of achievable data rate per UE link or parameter related to it. Optimization is done based on a mathematical function of this Rate_vec, e.g., max, min, sum, mean, with or without constraints. Examples for such optimization function are: max mean (Rates_vec) which represent maximization of the average over users rate and it is also equal to the maximization of the total rate of all users, max min (Rates_vec) which represents maximization of the minimal rate (i.e. of the weakest link); max(F), where F=w1*mean(Rates_vec)+w2*min(Rates_vec), with constraints: Rates_vec(u)>=Rmin_vec(u) for every user u. Note that the above rate vectors are per user and have number of components equal to the number of users participating in the MU-MIMO, namely N_{U}.

Mix of Communication and Non-communication parameters:
e.g., minimization of the gNB TX Power, under communication constraints: e.g., Rates_vec(u)>=Rmin_vec(u) for every user u. The gNB may also choose the EAs representing wireless links which do not optimize the rates but are the most reliable, and thus will need no repetitions and thus will reduce the total Time (e.g., the channel estimation time): e.g., needed to construct the DL precoder.

This reduction is due to less repetitive transmissions.

Stability criterion: under this criterion EAs with the most stable (less changing) links can be preferred.

The gNB may choose the EAs which effective channels are less changing in time: this can be deduced from the possible previous knowledge. As an illustration: a reflection from an object on the distance may have less power, but also less change than the Line-of-sight link. This can be especially of interest for fast-moving Ues (e.g., cars). This criterion can again be utilized with a set of constraints: e.g., Rates_vec(u)>=Rmin_vec(u) for every user u.

One of mathematical reasons related to the DL precoder construction is to find a good-performed set of EAs candidates for all users, which result in less correlative channels.

The gNB may also assist the selection of UE TX EAs, i.e., EAs used for uplink data transmission, and not for DL channel estimation via UL reciprocity. The gNB may indicate to the UE two separate indications holding a request for EAs to be used: one relating to the EAs used for DL reception—UE RX EAs, and a second one relating to EAs to be used for UL data transmission—UE TX EAs. The two indications may be identical. The indications can be also different as UE RX EAs may include pre-whitened physical channel matrix while for UE TX EAs this is not required.

For the case when the same set of EAs (Effective Antennas) is used for the downlink (UE RX EAs) and the uplink (UE TX EAs), the extended set of EAs is delivered to the gNB by UE (and from this set the EAs are further selected by the gNB). As an example, UE may construct this set as a result of multi-criterion optimization of the uplink and downlink cost functions and their corresponding constraints. This optimization may be done (in the heuristic manner) using modified physical channel H_{modified(u)}=M₍ᵤ₎H₍ᵤ₎. The EAs are constructed from the best (corresponding to the largest values of the σ₍ᵤ₎ₖ^{(modified)}) hermitically conjugated left eigenvectors uₖ₍ᵤ₎^{(modified)H} of the SVD decomposition of the modified physical channel H_{modified(u)}=Σₖ₌₁^{min (N}^{_{R(u)}}^{N}^{_{T}}⁾ σ₍ᵤ₎ₖ^{(modified)}u₍ᵤ₎ₖ^{(modified)}v₍ᵤ₎ₖ^{(modified)H}. Here, as a simplistic example, the modification matrix, M₍ᵤ₎, is constructed as M₍ᵤ₎=ω*1+(1−ω)*T₍ᵤ₎ where T₍ᵤ₎ is the matrix used for the interference rejection (e.g., the whiteneing matrix). Then, by varying a single real-valued parameter ω in the interval 0≤ω≤1 we may perform search and construct set of solution candidates (which yet may not satisfy the constraints). Here ω=1 ignores the interference and may be efficient for the uplink, and ω=0 takes the interference into account and may be efficient for the downlink. Note that UE here has advantage over the gNB in the knowledge of the interference (and of related T₍ᵤ₎ matrix, which is unknown to gNB). The interval of ω where all (uplink and downlink) constraints are satisfied represents possible solutions. Larger values of ω may favor the uplink and smaller values favor the downlink. Which value UE to choose may depend on multiple factors: e.g., what is preferable (uplink or downlink). Here, the preferability may be: in the rate demand, or be based on the learned statistics of the specific UE uplink and downlink usage, or it may be suggested by the gNB. Also, it may take into account different abilities of the UE and gNB (e.g., different number of iterations in the FEC processing which may influence the latency, and the MIMO decoding abilities of the UE and gNB). Note that smaller number of iterations may be favorable for power saving usage and it thus makes preference to the downlink (which is decoded by UE); in the above simplistic example: to the smallest possible values of w. We also note, that since the interference may be a dominant factor, then as a first approximation, the extended set of the EAs (when the same EAs are used for the downlink and the uplinks) can be according to the downlink (which suffers from the interference), i.e., be represented as a set of UE RX EAs. This manifests, from this additional angle, the importance of the UE RX EAs.

As a further generalization of the presented approach and for the optional case when the number of UE uplink effective antennas (UE TX EAs) are taken from a larger set of DL effective antennas (UE RX EAs) and hence are identical to some of the elements of this set. The multi-criterion optimization with constraints can be applied as described for this case as well. In particular, the modified channel can be used, and the effective antennas be constructed from the best eigen-vectors vectors (after hermitical conjugation) u₍ᵤ₎ₖ^{(modified)H} of the modified channel. We may always assume the indices k be ordered such that u₍ᵤ₎ₖ^{(modified)} be sorted from the largest to the smallest. Then we use 1≤k≤N̅_{R(u)} as UE RX EAs (or 1≤k≤ExtendedRxSetSize₍ᵤ₎ if a larger number of UE RX EAs candidates for user u is used to be delivered to the base station for further selection and this number is denoted here as ExtendedRxSetSize₍ᵤ₎) and 1≤k≤N̅_{T(u)} for UE TX EAs, where N̅_{T(u)} denotes the number of affective antennas used for the uplink transmission by user u. We will further note that the effective channel of the common effective antennas used for DL and UL can be optionally decoded by the base station via channel decoding from data (information data and optionally of pilots) of the uplink transmission. Then, the base station (if the above method of channel from data is used) needs the knowledge of the remaining (N̅_{R(u)}−N̅_{T(u)}) effective antennas to construct the precoder (or alternatively, if the extended set to be delivered to the base station then it needs knowledge of the remaining (ExtendedRxSetSize₍ᵤ₎−N̅_{T(u)}) effective antennas). Note that if the base station knows this extended set of UE RX EAs (from each UE TX EAs were taken by the UE), then the base station may optionally suggest, at the next iteration, the set of the EAs to be used for uplink.

EAs are defined per RE, hence this base station (gNB) communication may be large in size. To accommodate this large communication size various compression technics may be used. These techniques may include use of bit-maps, grouping multiple Res with a common EA set, taking advantage of a multi-step approach of EA construction, and/or time domain-based compression techniques.

The utilization of bit-maps can indicate sets of EAs candidates that are outside the scope of a provided list.

It is possible to group multiple Res that share a common EA set, thereby conveying a shared set of EAs candidates for the Res within that group. This grouping can also encompass wideband scenarios, spanning the entire available bandwidth.

Leveraging the multi-step process for constructing EAs (as discussed in the previous section), distinct sizes of Res groups are maintained for each EA construction step, with each Res group having its own set of EAs candidates.

Employing time domain-based compression techniques allows for a reduction in communication size by capitalizing on temporal correlations. For instance, conveying a single indication bit for “no change” can replace the need for multiple bits required in list selection, thus enhancing communication efficiency.

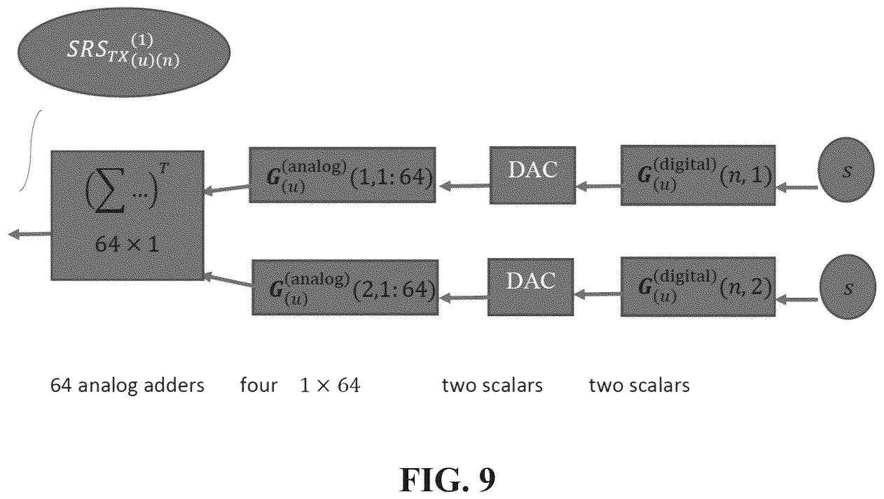

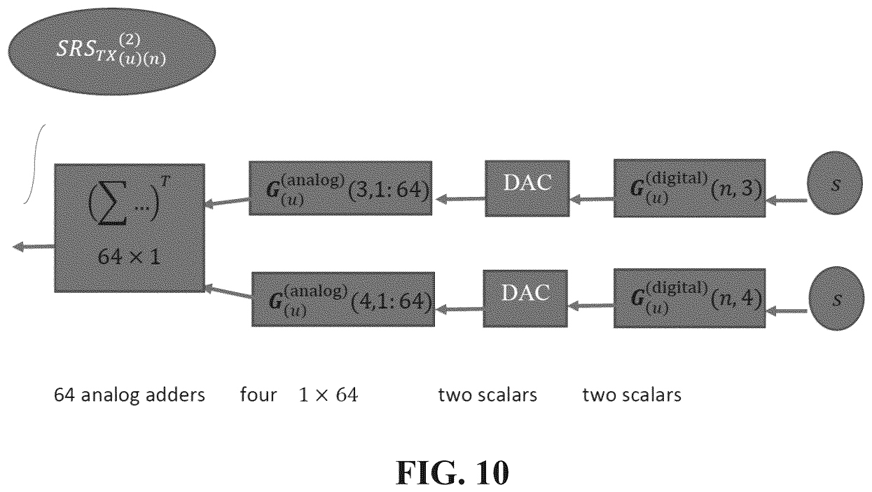

FIGS. 9 and 10 illustrate SRS transmission with smaller number of DAC (e.g., than the number of ADC). The number of DAC (here total of 2) can be smaller than the number of ADC (here total of 4). The UE can transmit the SRS in “chunks” and base station (gNB) is to perform integration of the chunks to construct the estimation of the full effective channel matrix. These “chunks” are better to be transmitted at the closely spaced in time and frequencies Res.

And then as illustrated in FIGS. 9 and 10 the base station (gNB) receives (at different Res: separated in time-frequency plane) the SRS at every RX antenna. Then, the base station (gNB) may add the SRSs which result is the full SRS attributed to EA with index n. (For clarity we note that for example, for 4 ADCs placed at the 4 outputs of the analog equalizer G₍ᵤ₎⁽²⁾ and using as 4 inputs for the digital equalizer G₍ᵤ₎⁽¹⁾, the RX can be done as illustrated in FIG. 8).

To further illustrate the versatility and large potential of the Effective Antennas let us present their ability for DL interference rejection. The UE array may incorporate the interference rejection mechanisms into the UE RX EAs construction. The interference here may concern either residual MU-MIMO concurrent transmissions or transmissions originating from external cells. This can be done by linearly pre-processing the output of the RX EAs or at an inner levels of the dimensionality reduction with a linear transform which rejects (zeroes) strong interference or/and whitens the noise (remaining after the rejection if it is applied before the whitening). We note, that thus a single Effective Antenna has ability to reject or reduce the interference, while a single physical antenna lacks this ability.

In some communication techniques, multi-step dimensionality reduction may be employed. At each step of this process, there may be an option to include interference rejection. This means not all stages might use interference rejection, but later stages may, if needed. Using interference rejection across stages may offer robustness and/or quick adaptation. Robustness may be provided when one stage misses interference, later stages can handle the interference, and also due to smaller input dimension of the later stage allowing better and more precise interference learning. If interference plus noise correlation matrices are used to construct interference rejection, with multi-step approach they do not need to be estimated at large dimensions but may be learned at smaller dimensions of the inner stages. Quick adaptation may be provided by having multiple stages. For example, having multiple stages may speed up system learning and adjustment to interference patterns.

The number of UE RX EAs may change based on needs and conditions. After handling interference, it may make sense to reduce the number of UE RX EAs to allow more users in Multi-User Multiple Input, Multiple Output (MU-MIMO) communications. But if interference changes or needs reassessment, increasing the number of UE RX EAs may be necessary. The User Equipment (UE) may also decide to increase the number if interference is not managed well. The final number may be coordinated with the base station.

An algorithm to construct MU-MIMO precoder at the base station side may be given for the single layer case, the precoder can be constructed from right best vector of the SVD decomposition of the full physical channel via the pseudo inverse. There is no need to invert the channels, and distinguishable from [SSH 2004 B, Q. H. Spencer, A. L. Swindlehurst, and M. Haardt, “Zero-forcing methods for downlink spatial multiplexing in multiuser MIMO channels,” IEEE Trans. Signal Process., vol. 52, no. 2, pp. 461-471, 2004.] the 1-layer self-channel σ₍ᵤ₎₁ for u=1:N_{U} do not need to enter the pinv ( . . . ). For the 3-user example (each user having single EA), the precoder can be constructed as:

$${P}_{{N}_{T} \times 3} = [ {p}_{( 1 )} , {p}_{( 2 )} , {p}_{( 3 )} ] = pinv ( [ \begin{matrix}{v}_{( 1 ) 1}^{H} \\ {v}_{( 2 ) 1}^{H} \\ {v}_{( 3 ) 1}^{H}\end{matrix} ] ) * {D}_{3 \times 3}$$

The diagonal matrix, D, is used for further possible power optimizations. This simple construction can be generalized and several eigen-vectors can be used for every user. For example, user #1 can operate with two layers, and users #2 and #3 with one layer:

$${P}_{{N}_{T} \times 4} = [ {p}_{( 1 )} , {p}_{( 2 )} , {p}_{( 3 )} ] = pinv ( [ \begin{matrix}{v}_{( 1 ) 1}^{H} \\ {v}_{( 1 ) 2}^{H} \\ {v}_{( 2 ) 1}^{H} \\ {v}_{( 3 ) 1}^{H}\end{matrix} ] ) * {D}_{4 \times 4}$$

Subsequently, this relation can be further generalized.

Assuming user “u” possesses v₍ₙ₎ layers, the approach involves selecting the “v₍ₙ₎” best (e.g., those corresponding to the largest channel SVD eigenvalues) right eigen-vectors. Subsequently, a matrix can be constructed from these selected eigen-vectors:

$${V}_{( u )}^{H} = [ \begin{matrix}{v}_{( u ) 1}^{H} \\ … \\ {v}_{( u ) {υ}_{u}}^{H}\end{matrix} ]$$

Then, the precoder matrix is directly constructed as

$${P}_{{N}_{T} \times υ} = [ {P}_{( 1 )} , … , {P}_{( {N}_{U} )} ] = pinv ( [ \begin{matrix}{V}_{( 1 )}^{H} \\ … \\ {V}_{( {N}_{U} )}^{H}\end{matrix} ] ) * {D}_{υ \times υ}$$

Here v is the total number of layers of all users:

$$υ = {\sum }_{u = 1}^{{N}_{U}} {υ}_{( n )}$$

The above precoder construction has smaller computation complexity than the previous methods presented method which uses the separate calculation of the NULL space per user and performs new SVD decomposition inside of it again per user. Its performance can be slightly less optimal and thus it represents a trade-off for the base station.

The Effective Antennas for the UEs are thus constructed via corresponding right eigen-vectors u₍ᵤ₎ₙ^{H} representing the way the signals from the RX antennas are combined, namely:

$${G}_{( u )} = [ \begin{matrix}{u}_{( u ) 1}^{H} \\ … \\ {u}_{( u ) {υ}_{u}}^{H}\end{matrix} ]$$

The effective channel construction using self-SVD is both computationally efficient and heuristic. It exhibits a significant attribute wherein, upon being communicated back to the Base Station, the Effective Antenna channels from each UE exhibit maximal possible gains (thus denoting UE array gains). This effectively addresses the issue of a weak UE transmitting its SRS towards a strong base station.

As another innovation in using this precoder construction, we note that the V₍ᵤ₎^{H} matrices can be obtained not from the SVD decomposition of the physical channel but from the modified by linear transform physical channel. This transform performs the interference rejection or reduction using e.g., nulling or whitening. The Effective Antennas for the UEs are thus constructed via corresponding right eigen-vectors u₍ᵤ₎ₙ^{H} (of the SVD of the linearly transformed physical channel) e.g., w₍ᵤ₎ₙ^{H}=u₍ᵤ₎ₙ^{(whitened)H} as it will be explained further.

As another innovation in using base station DL precoder construction, we note

$${P}_{{N}_{T} \times υ} = pinv ( \overline{H} ) * A * {D}_{υ \times υ} ,$$

Here A is a block-diagonal matrix (where each block has dimension N̅_{R(u)}×v₍ᵤ₎) and it has dimensions dim A=N̅_{R}×v, where.

$${\overline{N}}_{R} ≡ {\sum }_{u = 1}^{{N}_{U}} {\overline{N}}_{{R}_{( u )}}$$

$$and$$

$$\overline{H} = [ \begin{matrix}{G}_{( 1 )} {H}_{( 1 )} \\ ⋮ \\ {G}_{( {N}_{U} )} {H}_{( {N}_{U} )}\end{matrix} ] ,$$

$$and$$

$$dim \overline{H} = {\overline{N}}_{R} \times {N}_{T}$$

Here G₍ᵤ₎H₍ᵤ₎ corresponds to the channels for the RX EAs of the user u and not to the full channel matrix for this user which can be of larger or much larger size. Optimization of the matrix A is done by the base station (and it can be based e.g., on performance criteria, rate constraints per user and on the EAs corresponding channels stability criteria and on the robustness of the precoder criteria which can also take into account its less frequent update). In the case when number of EAs for every user is equal to the number of layers, matrix A may be optionally omitted and the following optional construction can be used

$${P}_{{N}_{T} \times υ} = pinv ( \overline{H} ) * {D}_{υ \times υ}$$

We also note that pseudoinverse pinv(M) can be generalized to include regularizations. Then, for any matrix M having less or equal number of rows than columns, the term corresponding to pinv (M)=M^{H}*(M^{H}M)⁻¹ can be generalized into M^{H}*(M^{H}M+α*1)⁻¹ for α>0, or M^{H}*(M^{H}M+diag(α))⁻¹ for vector a having all non-negative components (and diag(α) denotes diagonal matrix with components of vector a be on its diagonal).

Below are presented examples of EAs construction considering that G₍ᵤ₎⁽²⁾ is known (from the past, or it is suggested/indicated by the Base Station) or it has been already constructed (optimally, not optimally, or even based on a random set of the row vectors or be randomly chosen from a predefined alphabet). Then we perform the SVD decomposition of the H₍ᵤ₎⁽²⁾ matrix:

$${H}_{( u )}^{( 2 )} ≡ {G}_{( u )}^{( 2 )} {H}_{( u )} = {\sum }_{n = 1}^{min ( {N}_{T} , {N}_{( u )}^{( dim - reduction 2 )} )} {σ}_{( u )}^{( 2 )} {u}_{( u ) n}^{( 2 )} {v}_{( u ) n}^{( 2 ) H}$$

Here the dimensions of the vectors are:

$$dim {u}_{( u ) n}^{( 2 )} = {N}_{( u )}^{( dim - reduction 2 )} \times 1 ,$$

$$dim {v}_{( u ) n}^{( 2 ) H} = 1 \times {N}_{T}$$

We may always assume the indices n be ordered such that σ₍ᵤ₎ₙ⁽²⁾ be sorted from the largest to the smallest. Then, G₍ᵤ₎⁽¹⁾ rows are constructed from the hermitically conjugated column-vectors u₍ᵤ₎ₙ^{(1)H} attached to the N̅_{R(u)} largest σ₍ᵤ₎ₙ⁽²⁾. With the above sorting, we construct G₍ᵤ₎⁽¹⁾ as:

$${G}_{( u )}^{( 1 )} = [ \begin{matrix}{u}_{( u ) 1}^{( 2 ) H} \\ ⋮ \\ {u}_{( u ) {\overline{N}}_{{R}_{( u )}}}^{( 2 ) H}\end{matrix} ]$$

Note that for G₍ᵤ₎⁽¹⁾ construction, only u₍ᵤ₎ₙ⁽²⁾ are to be calculated. Since their dimension, N₍ᵤ₎^{(dim-reduction 2)}, is typically small, the calculation can be effectively performed as the principal vectors of the following symmetric matrix (the “left” correlation matrix):

$${C}_{( u )}^{( left )} ≡ {H}_{( u )}^{( 2 )} {H}_{( u )}^{( 2 ) H} , dim {C}_{( u )}^{( left )} = {N}_{( u )}^{( dim - reduction 2 )} \times {N}_{( u )}^{( dim - reduction 2 )}$$

### Namely:

C₍ᵤ₎^{(left)}u₍ᵤ₎ₙ⁽²⁾=λₙu₍ᵤ₎ₙ⁽²⁾

Here the eigenvalues are λₙ=(σ₍ᵤ₎ₙ⁽²⁾)². We are to select the N̅_{R(u)} eigenvectors corresponding to the N̅_{R(u)} largest eigenvalues.

Due to the matrix small-size, the eigen-vectors can be simply and effectively calculated even by a simple (reduced capabilities) UE.

Note that the knowledge of the large matrix H₍ᵤ₎ is not required. This property is important since for some design the UE may see the full physical channel only via G₍ᵤ₎⁽²⁾, then H₍ᵤ₎ may remain unknown. This is especially important for G₍ᵤ₎⁽¹⁾ be digital and G₍ᵤ₎⁽²⁾ be analog.

Above we have presented a way to construct G₍ᵤ₎⁽¹⁾ assuming G₍ᵤ₎⁽²⁾ be known. Now, we present several possible methods to construct G₍ᵤ₎⁽²⁾.

Let us present example 1 of G₍ᵤ₎⁽²⁾ construction. For example, assuming that H₍ᵤ₎ is known at UE, one can perform a single SVD (which can be of importance for reduced capability devices) of the <H₍ᵤ₎>, which is averaged over its support domain channel:

$$〈 {H}_{( u )} 〉 = {\sum }_{n = 1}^{min ( 64 , {N}_{T} )} {σ}_{〈 {H}_{( u )} 〉 n} {u}_{( {H}_{( u )} 〉 n} {v}_{〈 {H}_{( u )} 〉 n}^{H}$$

and construct G₍ᵤ₎⁽²⁾ from N₍ᵤ₎^{(dim-reduction 2)} rows as u_{<H}_{₍ᵤ₎}_{>n}^{H} for n=1:N₍ᵤ₎^{(dim-reduction 2)} where we assume the index n be ordered such that the σ<_{H}_{₍ᵤ₎}_{>n} are from the largest to the smallest. Namely, as an example (see FIG. 8A) with N₍ᵤ₎^{(dim-reduction 2)}=4:

$${G}_{( u )}^{( 2 )} = [ \begin{matrix}{u}_{〈 {H}_{( u )} 〉 1}^{H} \\ {u}_{〈 {H}_{( u )} 〉 2}^{H} \\ {u}_{〈 {H}_{( u )} 〉 3}^{H} \\ {u}_{〈 {H}_{( u )} 〉 4}^{H}\end{matrix} ] , \\ dim {G}_{( u )}^{( 2 )} = {N}_{( u )}^{( dim - reduction 2 )} \times {N}_{{R}_{( u )}} = 4 \times 64$$

This approach allows for the UE to perform large SVD not at every RE, but only once per its support domain (see FIG. 6). We note that if the G₍ᵤ₎⁽²⁾ belongs to an alphabet, then one may choose 4 alphabet rows which approximate the above u₍ᵤ₎ₙ^{H} rows in the best way (e.g., having the best projections).

Let us present example 2 of G₍ᵤ₎⁽²⁾ construction. Note that one can also (alternatively) find the best eigenvectors (corresponding to the largest eigenvalues λ) of the averaged right correlation matrix:

$${C}_{( averaged ) ( u )} = 〈 {H}_{( u )} {H}_{( u )}^{H} 〉 , \\ namely \\ {C}_{( averaged ) ( u )} {e}_{( u ) n} = {λ}_{n} {e}_{( u ) n} ,$$

then (for the above example with N₍ᵤ₎^{(dim-reduction 2)}=4)

$${G}_{( u )}^{( 2 )} = [ \begin{matrix}{e}_{( u ) 1}^{H} \\ {e}_{( u ) 2}^{H} \\ {e}_{( u ) 3}^{H} \\ {e}_{( u ) 4}^{H}\end{matrix} ]$$

Note that double averaging is possible as well:

$${C}_{( averaged ) ( u )} = 〈 〈 {H}_{( u )} 〉 {〈 {H}_{( u )} 〉}^{H} 〉$$

The G₍ᵤ₎⁽²⁾ support domain is divided into several sub-domains, over which the channel is averaged, and the right correlation matrix is constructed there from the averaged channel. Then, only several right correlation matrices are to be calculated and averaged.

We note that if the G₍ᵤ₎⁽²⁾ belongs to an alphabet, then one may choose 4 alphabet rows which approximate the above e₍ᵤ₎ₙ^{H} rows in the best way (e.g., having the best projections).

Let us present example 3 of G₍ᵤ₎⁽²⁾ construction. The construction can be done form random realizations (e.g., of alphabet rows) at every domain or the same random realization in every domain.

Let us present example 4 of G₍ᵤ₎⁽²⁾ construction. Another possible approach is to divide domains by smaller parts and choose the rows of the alphabet randomly at different sub-domains (or even per every RE), and then learn their performance (e.g., eye diagram or BER) and choose the best realization (expanding it over domain).

These are examples of equalizer G₍ᵤ₎⁽²⁾ construction. As we mentioned above, the equalizer G₍ᵤ₎⁽²⁾ can also be suggested to UE (for finite alphabet) by a gNB or it can be kept by UE be constant for some period of time (representing the simplest UE self-suggestion from the past). As further innovations we present below several aspects of the merging of the TX gNB antennas for EAs construction.

Let us now discuss another important issue for base station arrays with very large number of elements. For base station arrays having large number of physical antennas their channel estimation (by UE) can take a long time. Also, if the physical size of these antenna elements is small (which is the technological reason of the large their quantity) then the transmission from every such antenna element is weak, which negatively impacts the channel estimation (by UE) and reduces the range over which the channel estimation can be performed, hence reducing the area size where UE participating in the MU-MIMO are located. To address these challenges, the optional grouping or merging approach is proposed, wherein each group of gNB antenna elements receives a common input, with or without weightings.

Additionally, it's important to clarify that this merging is not intended for the actual downlink (DL) transmission of information signals. Instead, the merged transmission is directed towards UEs to facilitate Reciprocity-based MU-MIMO performance and the construction of UEs' receive effective antennas (EAs). We thus may say that different such mergings represent set of auxiliary BS (base station) TX EAs, which are not necessarily used further and are auxiliary in this sense (despite their usage as actual BS TX EAs is also an option). The transmission from the set of auxiliary BS TX EAs is utilized by UE to construct UE RX EAs (the construction by UE uses the physical channel matrix of these auxiliary BS Tx EAs (this channel matrix can be also optionally further modified by UE, as we described, for optional interference rejection.

Another innovation is represented by Channel estimation via re-encoding.

If UE uses identical UL and DL EAs, then the channel estimation for the UL precoder construction can be performed via the UL decoded data which serves as pilots. The decoded post FEC (Forward Error Correction) UL data will have to be FEC re-encoded to construct these data-based pilots.

The advantage of this approach is that all the data tones can be used as pilots as long as the bits were correctly decoded (this is checked via the CRC (Cyclic Redundancy Check)). This allows to construct the precoder from the most recent and accurate channel data.

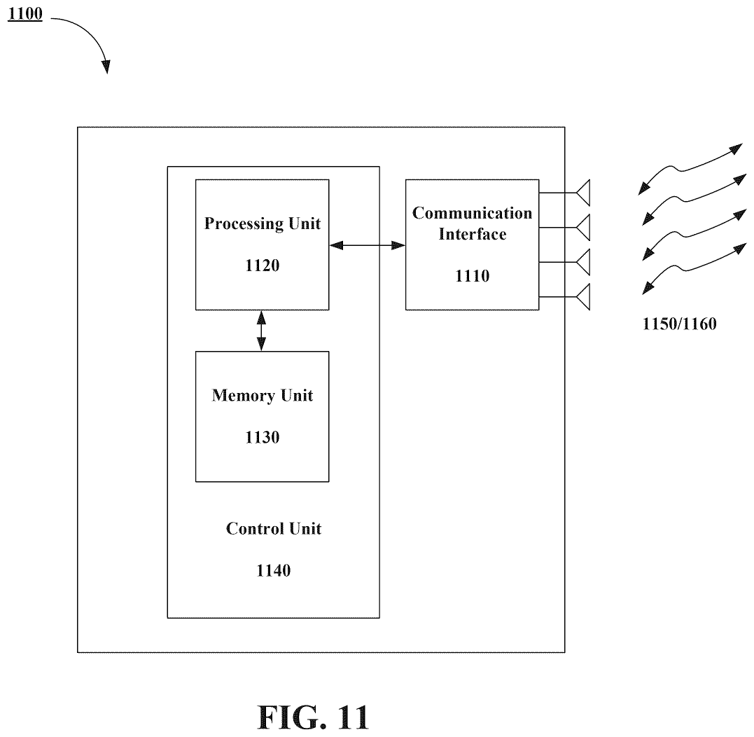

FIG. 11 is a diagram illustrating a UE with enhancing Reciprocity-based MU-MIMO performance. In FIG. 11, a UE device 1100 is illustrated, which may enhance Downlink (DL) channel estimation in a wireless communication system. The UE device includes various components. The Communication Interface 1110 may receive DL signals 1150 from a gNB (Base Station) to facilitate Reciprocity-based MU-MIMO performance. The Processing Unit 1120 estimates the DL channel response based on the received DL signals. The Memory Unit 1130 stores instructions that, when executed by the Processing Unit, allow the UE device to perform various operations related to DL channel enhancement. Control Unit 1140 controls the operations of the Communication Interface, Processing Unit, and Memory Unit based on the stored instructions.

The UE device 1100 may perform the following optional operations to enhance Reciprocity-based MU-MIMO performance. The UE estimates the DL channel response based on the received DL signals using the Processing Unit. Using the estimated DL channel response, the UE specifies at least one UE Rx EA (Effective Antenna) candidate. The UE transmits UL signals 1160 to facilitate reciprocity-based MU-MIMO performance by the gNB. The transmission is performed via the UE Rx EA candidates. The UE receives indications of selected UE Rx EA candidates for DL transmission from the gNB. Using the selected UE Rx EA(s), the UE decodes DL transmission data. The UE utilizes the Control Unit to manage the operations of various components based on the instructions stored in the Memory Unit.

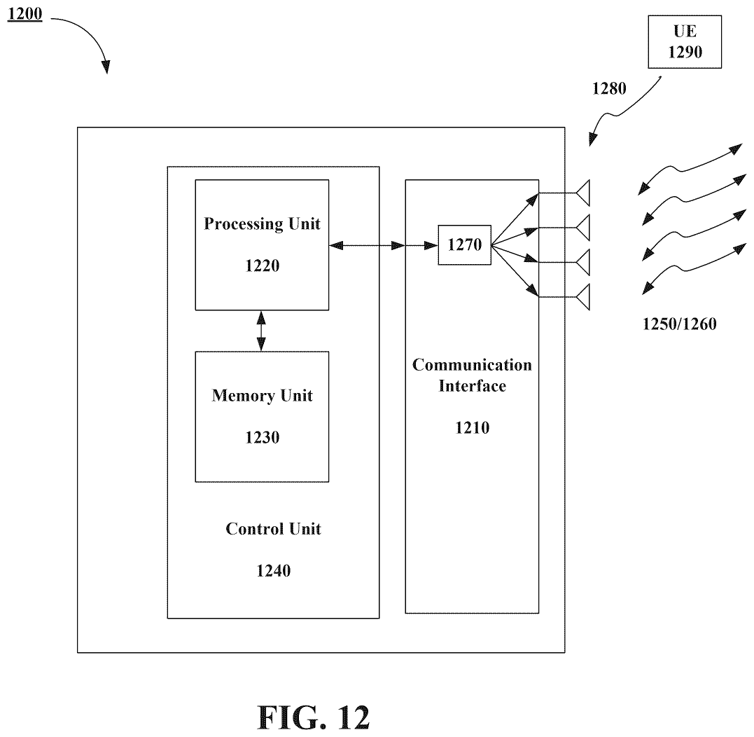

FIG. 12 is a diagram illustrating a base station (gNB) 1200 with Enhancing Reciprocity-based MU-MIMO performance. In FIG. 12, a gNB (Base Station) device 1200 is depicted, which may enhance Downlink (DL) channel estimation in a wireless communication system. Similar to FIG. 11, the gNB device includes functional components. Communication Interface 1210 receives DL signals 1250 from a gNB to facilitate Reciprocity-based MU-MIMO performance. Processing Unit 1220 estimates the DL channel response based on the received DL signals. Memory Unit 1230 stores instructions that guide the gNB device in enhancing Reciprocity-based MU-MIMO performance. Control Unit 1240 governs the operations of different components based on the stored instructions. The gNB device may perform the following optional operations to enhance Reciprocity-based MU-MIMO performance. The gNB estimates the DL channel response based on the received DL signals using the Processing Unit. Utilizing the estimated DL channel response, the gNB selects UE 1290 Rx EA candidates 1280 for DL transmission. The gNB constructs a DL precoder 1270 based on the estimated DL channel response and the selected UE Rx EA candidates. The gNB transmits DL signals using the constructed DL precoder to the UE for enhanced Reciprocity-based MU-MIMO performance. The gNB may perform other operations, such as decoding received UL signals, selecting UE Rx EA candidates, and controlling various components using the Control Unit and the instructions stored in the Memory Unit.

Below are presented examples of EAs construction considering the interference rejection at the full UE array dimension. The EAs candidates can be constructed for example from the SVD decomposition of the full physical channel multiplied by the matrix of linear transformer T which is supposed to treat the interference. Examples of T are the whitening matrix, the nulling interference matrix or their combination (where some interference is nulled, and some is whitened).

In a first example, the physical channel H₍ᵤ₎ and for the whitener of the interference noise given by matrix W₍ᵤ₎ proposing the utilization of the SVD decomposition of the whitened physical channel:

$${W}_{( u )} {H}_{( u )} = {\sum }_{m = 1}^{min ( {N}_{{R}_{( u )} , {N}_{T}} )} {σ}_{( u ) m}^{( whitened )} {u}_{( u ) m}^{( whitened )} {v}_{( u ) m}^{( whitened ) H} .$$

Then, the mentioned SU-MIMO is optimized (per RE) with e.g., EAs for user (u) be constructed from the best (hermitically conjugated) u₍ᵤ₎ₘ vectors as:

w₍ᵤ₎ₙ^{H}=u₍ᵤ₎ₙ^{(whitened)H}

It allows to extract from the whitened channel the largest possible gains σ₍ᵤ₎ₘ^{(whitened)}. The effective channel for EA #n is h₍ᵤ₎ₙ≡σ₍ᵤ₎ₘ^{(whitened)}v₍ᵤ₎ₘ^{(whitened)H}. This is SU-MIMO heuristic way, since it ignores the other users (we will discuss that). This generalizes the SVD based EAs construction, which takes now into account the interference rejection. Note that a way to construct the whitening matrix, W₍ᵤ₎, is from any factorization of the interference plus ambient noise correlation matrix C₍ᵤ₎ₙ is known as:

$${W}_{( u )} = {F}_{( u )}^{- 1} , where {C}_{( u ) n} = {F}_{( u )} {F}_{( u )}^{H}$$

The factorization is not unique (e.g., it is up to right multiplication of F₍ᵤ₎ by any orthonormal unitary matrix [symbol] , such that [symbol] [symbol] ^{H}=1. Here matrices F₍ᵤ₎, [symbol] and 1 have equal dimensions. This may be directly checked: (F₍ᵤ₎ [symbol] )(F₍ᵤ₎ [symbol] )^{H}=F₍ᵤ₎ [symbol] [symbol] ^{H}=F₍ᵤ₎^{H}=F₍ᵤ₎F₍ᵤ₎^{H}.

In a second example, when the interference rejection is performed via nulling, then the nulling matrix P₍ᵤ₎ is used instead of W₍ᵤ₎.

$${P}_{( u )} {H}_{( u )} = {\sum }_{m = 1}^{min ( {N}_{{R}_{( u )} {N}_{T}} )} {σ}_{( u ) m}^{( ZF )} {u}_{( u ) m}^{( ZF )} {v}_{( u ) m}^{( ZF ) H}$$

and construct the EAs as:

w₍ᵤ₎ₙ^{H}=u₍ᵤ₎ₙ^{(ZF)H}

taking the vectors with indices n corresponding to the largest sigmas (σ₍ᵤ₎ₘ^{(ZF)}).

With zero-forcing, or nulling approach, the component of the interference channels may be eliminated: [symbol] ₍ᵤ₎ᵢ (if they are known; every such vector has dimension of the UE RX array, namely dim [symbol] ₍ᵤ₎ᵢ=N_{R(u)}×1). For example, the original set of may be orthogonalize: { [symbol] ₍ᵤ₎ᵢ} into the interference orthonormal basis {e₍ᵤ₎ᵢ} (via Gramm-Schmidt) and then introduce:

$${P}_{( u )} ≡ 1 - {\sum }_{i = 1}^{{N}_{i}} {e}_{( u ) i} {e}_{( u ) i}^{H}$$

For a single strong interference channel vector [symbol] ₍ᵤ₎, this leads to:

$${P}_{( u )} ≡ 1 - \frac{{( u )}_{} {( u )}_{H}^{}}{{‖ {h}_{( u )} ‖}^{2}}$$

In a third example, both approaches may be combined, with nulling being performed over several most powerful interferers and whitening the rest.

$${W}_{( u )} {P}_{( u )} {H}_{( u )} = {\sum }_{m = 1}^{min ( {N}_{{R}_{( u )} , {N}_{T}} )} {σ}_{( u ) m}^{( ZF + whitened )} {u}_{( u ) m}^{( ZF + whitened )} {v}_{( u ) m}^{( ZF + whitened ) H}$$

Then, EAs for user (u) be constructed as from the best (of largest sigmas):

$${w}_{( u ) n}^{H} = {u}_{( u ) n}^{( ZF + whitened ) H}$$

Such an approach may add robustness, since the correlation matrix with several strong interferers can be close to singular (if the number of interferers is smaller than the size of the correlation matrix). Differently from physical antennas, even a single EA can reject interference.

Note that the above presented DL precoder construction (see [0083]) based on the pseudo-inverse of the SVD parts of the users' channels can also be applied to the transformed channels (e.g., to the pre-whitened channels). As we presented for the pre-whitened channel example in [0089] the equalizer part is given by w₍ᵤ₎ₙ^{H}=u₍ᵤ₎ₙ^{(whitened)H} row vectors, and the VH matrix in [0083] is assembled from, v₍ᵤ₎ₘ^{(whitened)H} row vectors).

We also importantly note that RX EAs may represent not the full chain of the equalizer but one or several its elements with larger dimensions (e.g., G₍ᵤ₎⁽²⁾). This is illustrated in FIG. 8C. This is a compromise to have a larger number of EAs (e.g., larger than the number of information layers) and use it for learning and rejecting interference independently of the EAs construction. This adds robustness to the learning of the interference noise plus ambient noise correlation matrix. With the dimensionality reduction approach, the noise correlation matrix has smaller or much smaller number of elements than the noise correlation matrix based on the physical array. The total noise (including the interference) is learned thus at the outputs of the EAs equalizer (e.g., at the 4 outputs if the equalizer size is 4×64; the total interference plus noise correlation matrix over the 4 EAs will have size of 4×4 vs much larger 64×64 noise correlation matrix over the physical RX antennas). Regarding the blocks which are placed after G₍ᵤ₎⁽²⁾ they can be dynamically adjusted (e.g., due to changing interference) without change in the 4 EAs. The corresponding design is illustrated in FIG. 8C. Here T₍ᵤ₎⁽¹⁾ performs interference rejection (e.g., whitening) over the output of the 4 effective antennas (4 EAs) represented by the dimensionality reduction equalizer G₍ᵤ₎⁽²⁾. Then, he final step of the equalizer G₍ᵤ₎⁽¹⁾ is applied performing further dimensionality reduction to 2 outputs (e.g., serving two information layers).

As a possible example, G₍ᵤ₎⁽¹⁾ can be constructed (e.g., from the 2 best hermitically conjugated left eigenvectors, u₍ᵤ₎ₙ^{H}, of the SVD of the 4×N_{T} channel matrix

$${H}_{( u )}^{( trasformed 2 )} ≡ {T}_{( u )}^{( 1 )} {G}_{( u )}^{( 2 )} {H}_{( u )}$$

similarly, to as described in [0089]).

As another example we note that stages of the equalizer matrices can be proceeded by permutation matrices. The permutational degrees-of-freedom allows efficient DSP realization and it also may make equalized information and interference channels be less correlative. The permutation degrees-of-freedom allows efficient DSP realization, and it also may make equalized information and interference channels less correlative. This analytically corresponds to the equalizer construction as:

$${G}_{( u )} = {\prod }_{n = 1}^{{N}_{{G}_{( u )}}} {G}_{( u )}^{( n )} {T}_{( u )}^{( n )} , where {T}_{( u )}^{( n )} = {W}_{( u )}^{( n )} {P}_{( u )}^{( n )} {Π}_{( u )}^{( n )}$$

Here W₍ᵤ₎⁽ⁿ⁾ represents the optional whitener of the interference noise, and P₍ᵤ₎⁽ⁿ⁾ is optional rejector of the noise and Π₍ᵤ₎⁽ⁿ⁾ is an optional permutation matrix. A possible example of 2-step dimensionality reduction containing the outer-side permutation is:

G₍ᵤ₎=G₍ᵤ₎⁽¹⁾T₍ᵤ₎⁽¹⁾G₍ᵤ₎⁽²⁾Π₍ᵤ₎⁽²⁾.

The permutation can be also effective as a tool when order in which dimensions are reduced is fixed (e.g., due to hardware design or as a learned previously weights by AI or ML (Machine learning). The dimensionality reduction can be considered as filtering of a sub-set of several antennas and in some hardware designs the indices in that sub-set may stay constant. Then, the permutation degrees of freedom may better the performance allowing more suitable dimensionality reduction since they manifest more possible input options to the next stage (and no permutation is just a unit matrix, which preserves the natural order of inputs).

The number of these permutations can be reduced about all possible permutations since the addition of different parts is additive. This may allow to reduce the combinatorial complexity of dimensionality reduction stages.

After the total (interference and ambient) noise is learned, the number of EAs can (optionally) be decreased (e.g., to 2 EAs for two layers, vs above mentioned 4 EAs). This may allow us to incorporate more users into the MU-MIMO service. The corresponding design is illustrated in FIG. 8B. In some embodiments, the number of UE RX EAs may also be enlarged after the noise is determined, e.g., interference noise and ambient noise, for example, if the UE observes that the current number of UE RX EAs is insufficient to treat the interference. The number of possible EAs for UEs can be also agreed with the BS.

An example presenting how Base Station may use channel estimation from the decoded uplink symbols (transmitted by a UE to the Base Station) in order to construct DL precoder. Here is one possible example of the algorithm allowing channel estimation from the decoded data at the base station. The estimation of the channel matrix from already decoded by FEC data (for MU-MIMO) can be done as (we write the received signal vector equation, see the dimensions below):

$$r = {\sum }_{n = 1}^{{N}_{total}} {h}_{n} * {s}_{n} + n = H s + n$$

Here, Nₜₒₜₐₗ is the total number of the spatial streams from all users (e.g., is there are three users with 4 spatial streams each, then the Nₜₒₜₐₗ=3*4=12). The dimensions may be:

$$dimr = {N}_{T} \times 1 , dimn = {N}_{T} \times 1 , {dimh}_{n} = {N}_{T} \times 1 ,$$

$$dimH = {N}_{T} \times {N}_{total} , dim s = {N}_{total} \times 1 ,$$

Here the symbol vector represents column vector of stacked (decoded) symbols at RE:

$$s = [ \begin{matrix}{s}_{1} \\ ⋮ \\ {s}_{total}\end{matrix} ]$$

and the channel matrix H is:

$${H}_{{N}_{T} \times {N}_{total}} = [ {h}_{1} , … , {h}_{total} ] .$$

Assuming the channel matrix be approximately constant upon NE RE (“E” stands for “elements”), where:

N_{E}≥Nₜₒₜₐₗ

we may write the equations for the channel matrix as:

$$[ {r}_{( i = 1 )} , … , {r}_{( i = {N}_{E} )} ] = H * [ {s}_{( i = 1 )} , … , {s}_{( i = {N}_{E} )} ] + [ {n}_{( i = 1 )} , … , {n}_{( i = {N}_{E} )} ]$$

Introducing matrices:

$${R}_{{N}_{T} \times {N}_{E}} = [ {r}_{( i = 1 )} , … , {r}_{( i = {N}_{E} )} ] , {S}_{{N}_{total} \times {N}_{E}} = [ {s}_{( i = 1 )} , … , {s}_{( i = {N}_{E} )} ]$$

the above equation is re-written in the matrix form:

$${R}_{{N}_{T} \times {N}_{E}} = {H}_{{N}_{T} \times {N}_{total}} * {S}_{{N}_{total} \times {N}_{E}} + {N}_{{N}_{T} \times {N}_{E}}$$

To find the channel matrix apply the pseudoinverse of the S matrix (we use that Nₜₒₜₐₗ≤N_{E})

$$pinv ( S ) = {S}^{H} * {( {S}^{H} S )}^{- 1}$$

form the right side of the equation:

$${R}_{{N}_{T} \times {N}_{E}} * {S}^{H} * {( {S}^{H} S )}^{- 1} = {H}_{{N}_{T} \times {N}_{total}} * {S}_{{N}_{total} \times {N}_{E}} {S}^{H} * {( {S}^{H} S )}^{- 1} + {N}_{{N}_{T} \times {N}_{E}} {S}^{H} * {( {S}^{H} S )}^{- 1}$$

Since S_{N}_{ₜₒₜₐₗ}_{×N}_{_{E}}S^{H}*(S^{H}S)⁻¹=1, thus (ignoring the noise term which is also reduced by the “averaging” over N_{E} REs) arrive to the channel estimator relation from the known decoded symbols:

$${\hat{H}}_{{N}_{T} \times {N}_{total}} = {R}_{{N}_{T} \times {N}_{E}} * p i n v ( {S}_{{N}_{total} \times {N}_{E}} )$$

Note that the regularized pseudoinverse (with regularized parameter α≥0) would be written as:

$${\hat{H}}_{{N}_{T} \times {N}_{total}} = {R}_{{N}_{T} \times {N}_{E}} * {S}^{H} * {( {S}^{H} S + α * 1 )}^{- 1}$$

Here the unit matrix 1 has the following dimensions 1_{N}_{ₜₒₜₐₗ}_{×N}_{ₜₒₜₐₗ}. This approach can be further extended to estimation with windowing as (window can take into account the fact that the RE used for channel estimation are distanced from the RE at channel is to be determined):

We rewrite the received vector equation with weights by multiplying every relation by weights:

$${r}_{( i )} * {w}_{( i )} = H {s}_{( i )} {w}_{( i )} + {n}_{( i )} {w}_{( i )}$$

Here, the index (i) represents a relative position in the window box. Stacking these relations together leads to:

$$[ {r}_{( i = 1 )} {w}_{1} , … , {r}_{( i = {N}_{E} )} {w}_{{N}_{E}} ] = H * [ {s}_{( i = 1 )} {w}_{1} , … , {s}_{( i = {N}_{E} )} {w}_{{N}_{E}} ] + [ {n}_{( i = 1 )} {w}_{1} , … , {n}_{( i = {N}_{E} )} {w}_{{N}_{E}} ]$$

Then, after manipulations (we use again the pseudo-inverse and heuristically importantly ignore that the noise has also been modified by the weights):

$${\hat{H}}_{{N}_{T} \times {N}_{total}} = {R}_{{N}_{T} \times {N}_{E}} {D}_{WEIGTS} * {S}^{H} * {( {S}^{H} {D}_{WEIGTS} S )}^{- 1}$$

$$or$$

$${\hat{H}}_{{N}_{T} \times {N}_{total}} = {R}_{{N}_{T} \times {N}_{E}} {D}_{WEIGTS} * {S}^{H} * {( {S}^{H} {D}_{WEIGTS} S + α * 1 )}^{- 1}$$

Here the diagonal matrix D_{WEIGTS} has squared weights values on its diagonal:

D_{WEIGTS(i,j)}=δᵢⱼwᵢ²

Note that one of the arguments why nonlinear precoding is not currently used for wireless communications is that the channel knowledge is limited. The suggested “channel from decoded data” may allow us to use this promising technology. We note that the reconstructed channel is the recent channel. This is of importance and brings advantage for the wireless environment presenting a solution to the problem of channel variability. It helps to extract the recent channel while the usage of an outdated channel might be harmful (since it may e.g., reduce information gains and inject interference (e.g., due to non-exactness of the ZF precoder design)). We also note that the decoded data is large (much larger than the pilot based data) which may better the precision of the channel estimation and be an additional advantage of this approach. We also note that the approach is general since it is based only on the ability to decode data (which is a part of the uplink processing for any wireless technology). In passing we note that the approach can be applied to pilot based technologies (when some data in some REs is known, and not need to be FEC decoded at these specific REs, and it thus directly enters at these RE the parts of symbol elements s (i) in the presented above equations) or to recent promising (and mentioned for 6G) pilotless technology. The constructed DL precoder based on this approach will serve UEs with any number of EAs (assuming the same EAs are used for UL and for DL). This is always the case of the devices with 1-physical-antenna.

### Reciprocity-Based MU-MIMO Enhancement for UE

One embodiment may describe a method for augmenting Downlink (DL) reciprocity-based MU-MIMO performance. The UE may specify one or more UE Rx Effective Antennas (EA) candidates. Subsequent to this, the UE may transmit Uplink (UL) signals that could include UL Sounding Reference Signals (SRS) for reciprocity-based MU-MIMO. These signals may assist the gNB in estimating the DL channel.

Once received at the gNB, the DL channel response may be estimated using the concept of UL reciprocity. Following this estimation, the gNB may select one or more UE Rx EA candidates based on their estimated performance in facilitating DL transmission, among other factors like channel conditions, interference levels, and UE mobility.

The gNB might further design a DL precoder. This precoder's design may focus on optimizing spatial information of the selected UE Rx EA(s), potentially minimizing interference, and aiming to maximize signal quality. The UE, upon reception, may decode the DL data utilizing one or more of the specified or selected UE Rx EA(s).

In some scenarios, the selection of UE Rx EA candidates may undergo iterative refinement. This might be based on several inputs such as feedback from the gNB, the estimated DL channel response, or historical data from the UE. Random or predefined selection methodologies might also be implemented.

### gNB Operations for MU-MIMO Enhancement

The gNB might receive UL signals from the UE, transmitted via the specified UE Rx EA(s). Based on these signals, the gNB could estimate the DL channel response. It may also select one or more UE Rx EA candidates for DL transmission, taking into account various factors. This might also include the adjustment of these candidates based on changes in the wireless environment. Additionally, the gNB may transmit information regarding the selection of said UE Rx EA candidate(s) back to the UE.

### Hardware Configurations and Components

A gNB device, aiming to boost Reciprocity-based MU-MIMO performance, might comprise a processing unit and a memory unit loaded with operational instructions. Upon their execution, these instructions could guide the gNB device in tasks like DL channel response estimation and DL precoder construction. Moreover, the gNB might also select UE Effective Antenna(s) or EA(s) from pre-defined candidates and communicate these selections to the UE.

Importantly, the gNB device may have the capability to construct UE Rx EAs via merging its own Tx antenna elements. This method of construction could then be refined based on feedback from the UE or specific performance metrics.

Lastly, there might be a focus on designing or selecting UE Rx EAs with inherent interference rejection capabilities. Techniques such as spatial filtering or other interference mitigation methods may be employed to potentially enhance signal quality and performance.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for enhancing Downlink (DL) Reciprocity-based MU-MIMO performance in a wireless communication system, comprising the steps of:
specifying at least one UE Rx EA (Effective Antenna) candidate;
transmitting UL signals from the UE to facilitate reciprocity-based DL channel estimation by a base station, wherein the transmission is carried out via said specified at least one UE Rx EA;
estimating a DL channel response at the base station using UL reciprocity;
selecting at least one of said specified UE Rx EA candidates for DL reception;
constructing a DL precoder at the base station based on said estimated DL channel response and the selected UE Rx EA(s); and
decoding DL transmission data at the UE using at least one of said specified UE Rx EA(s).

2. The method of claim 1, further comprising specifying at least one UE Rx EA candidate based on at least one of: information received from the base station, estimated DL channel response, past accumulated information or knowledge at UE, random selection, predefined selection, received signal quality, interference level, user mobility status, and historical performance data.

3. The method of claim 1, wherein said selecting at least one of said specified UE Rx EA candidates for DL reception is based on at least one of: communication related criteria, mix of communication and non-communication parameters, stability criterion, performance in facilitating DL transmission, signal-to-interference-plus-noise ratio (SINR), channel conditions, network load and information communicated from the UE.

4. The method of claim 1, wherein the base station communicates information to assist the UE in specifying the UE Rx EA.

5. The method of claim 4, wherein the information comprising a candidate options list.

6. The method of claim 1, further comprising the step of transmitting an indication from the base station regarding the selected UE Rx EA candidates for DL reception.

7. The method of claim 1, wherein the UL signals for channel estimation utilizes Sounding Reference Signals (SRS).

8. The method of claim 1, wherein reciprocity-based DL channel estimation is facilitated via UL transmission when the number of UE Rx EAs exceeds the number of UE Tx EAs, wherein the UL SRS transmission is segmented into multiple chunks, each chunk holding one or more ports, and the chunks are selected for transmission one after the other.

9. The method of claim 1, wherein UL data transmission is carried out via at least one of said selected at least one UE Rx EA candidate.

10. The method of claim 1, wherein said estimating a DL channel response is based on decoded UL data transmission.

11. The method of claim 1, wherein the construction of the UE TX EAs, representing effective antennas for the uplink, comprises a subset of the UE RX EAs, representing effective antennas for the downlink.

12. The method of claim 11, wherein, when the number of UE TX EAs is fewer than the number of UE RX EAs, the UE TX EAs are decoded from received data, and the residual UE RX EAs are transmitted to the base station using SRS transmission, thereby reducing the quantity of EAs required for SRS transmission, wherein decoding from the received data allows for the use of the most recent information available at the base station, reducing channel ageing.

13. The method of claim 1, wherein the base station utilizes decoded MU-MIMO uplink data for constructing the DL precoder to facilitate downlink transmission for users participating in the MU-MIMO, said uplink data optionally including known uplink pilot symbols; and wherein said DL precoder construction is employed when the UE utilizes identical EA, whether singular or multiple, for both UL and DL, such that the sets of UE RX EAs and UE TX EAs are congruent.

14. The method of claim 13, wherein the uplink transmission is executed without the use of pilots and is decoded based on a specially constructed constellation shape, said decoding optionally enhanced through the utilization of artificial intelligence (AI) and machine learning (ML) methodologies, wherein such pilotless technology, being indicative of prospective 6G advancements, is employed to integrate data decoding capabilities with DL precoder construction.

15. The method of claim 1, where each UE RX EA has interference rejection capabilities, utilizing spatial filtering or other interference mitigation techniques to enhance signal quality.

16. The method of claim 15, where the number of UE RX EAs is dynamically adjusted, decreasing after interference is learned to accommodate more MU-MIMO users and increasing when the wireless environment changes, increasing when interference needs reassessment, or increasing when the UE determines current EAs are insufficient to address interference, and wherein the EA count for UEs coordinated with the BS.

17. The method of claim 1, further comprising the steps of:
performing multi-step dimensionality reduction on the DL channel response estimated at the base station, wherein a larger matrix is used for aggregating broader sets of Resource Elements (RE) and is updated less frequently, and a smaller matrix is defined per smaller sets of RE or per individual RE;
allocating values for the larger matrix and the smaller structure matrix along the frequency axis, wherein allocations are either regular or variable based on channel variability; and
utilizing both the larger matrix and the smaller structure matrix to refine the DL precoder construction at the base station.

18. The method of claim 17, wherein the multi-step dimensionality reduction includes interference rejection capabilities to enhance signal quality.

19. A method for enhancing Downlink (DL) Reciprocity-based MU-MIMO performance, performed by a base station, comprising the steps of:
receiving UL signals from the UE for reciprocity-based DL channel estimation, wherein the UL signals are transmitted by the UE via specified UE Rx EA (Effective Antenna) candidates;
estimating the DL channel response based on the received UL signals using UL reciprocity;
selecting at least one UE Rx EA candidate specified by the UE for DL reception based on the estimated DL channel response;
constructing a DL precoder based on the estimated DL channel response and the selected UE Rx EA(s); and
transmitting DL transmission data to the UE using the DL precoder.

20. The method of claim 19, further comprising iteratively refining the selection of UE Rx EA candidates and DL precoder based on changing wireless environment conditions.

21. The method of claim 19, wherein the DL precoder is designed to minimize interference and maximize signal quality.

22. The method of claim 19, further comprising communicating the selection of said UE Rx EA candidate(s) to the UE.

23. The method of claim 19, wherein the base station communicates to the UE information to assist the UE in specifying the UE Rx EA.

24. The method of claim 23, where said communicates to the UE information from the base station holds UE Rx EA candidate options list.

25. The method of claim 19, wherein the base station selects the UE Rx EA based on at least one of: communication related criteria, mix of communication and non-communication parameters, stability criterion, performance in facilitating DL transmission, signal-to-interference-plus-noise ratio (SINR), channel conditions, network load and information communicated from the UE.

26. The method of claim 19, wherein specifying the at least one UE Rx EA candidate comprises constructing a set as a result of multi-criterion optimization of uplink and downlink cost functions and their associated constraints.

27. The method of claim 19, wherein a ZF (zero forcing) DL precoder is constructed at the base station using the pseudoinverse of select concatenated right, hermitically conjugated, eigen-vectors, v₍ᵤ₎ₙ^{H}, derived from the singular value decomposition (SVD) of the physical channel matrix H₍ᵤ₎ or from the SVD of a transformed physical channel matrix T₍ᵤ₎H₍ᵤ₎;
each effective antenna for user ‘u’ being characterized by the corresponding hermitically conjugated left SVD eigen-vector u₍ᵤ₎ₙ^{H} aligned with the aforementioned v₍ᵤ₎ₙ^{H}), where ‘best’ is determined by those corresponding to the largest singular values σ₍ᵤ₎ₙ;
the transformation involving multiplication of the physical channel matrix by a linear transform matrix T₍ᵤ₎ performing designed for functions such as interference rejection or pre-whitening; and
wherein the claim is applicable for any number of effective antennas when a modification matrix is present, and, in the absence of a modification matrix, is applicable when at least one user employs multiple UE RX effective antennas; the ZF approach encapsulating modifications introduced by regularization techniques.

28. The method of claim 19, wherein a ZF (zero forcing) DL precoder is constructed at the base station based on the pseudoinverse of the effective channels associated with the UE RX EAs, applicable when at least one user is equipped with more than a single UE RX effective antenna.

29. A base station created to enhance reciprocity-based MU-MIMO performance in a wireless communication system, the base station comprising:
a base station processing unit; and
a memory unit that stores instructions for the base station's operations, the instructions causing the base station to:
estimate the DL channel response based on received UL signals in order to construct a DL precoder, while a memory unit stores instructions for the base station's operations, and
configure its precoder for MU-MIMO operation and transmit data encoded using said precoder, wherein the base station processing unit further includes a control unit that oversees the device's operations to enhance reciprocity-based MU-MIMO performance.

30. The base station of claim 29, the instructions further causing the base station to select UE EA (a) to be used out of candidates previously defined; and communicates it to the UEs.

31. The base station of claim 30, wherein said selecting at least one of said specified UE Rx EA candidates for DL reception is based on at least one of: communication related criteria, mix of communication and non-communication parameters, stability criterion, performance in facilitating DL transmission, signal-to-interference-plus-noise ratio (SINR), channel conditions, network load and information communicated from the UE.

32. The base station of claim 29, wherein the base station processing unit is configured to merge multiple base station Tx antenna elements, forming a set of auxiliary base station TX EAs, said set of auxiliary base station TX EAs, while available for use as actual base station TX EAs, are not necessarily employed for subsequent transmissions, a user equipment (UE) utilizes transmissions from said set of auxiliary base station TX EAs to formulate UE RX EAs, wherein the formulation by the UE is anchored on the physical channel matrix associated with the auxiliary base station Tx EAs, with said physical channel matrix being optionally modified by the UE for interference rejection.

33. The base station of claim 29, wherein the constructed UE Rx EAs are iteratively refined based on feedback from the UE or performance metrics.

34. The base station of claim 29, wherein the instructions stored in the memory unit further cause the base station to select UE Rx EAs with inherent interference rejection capabilities, utilizing spatial filtering or other interference mitigation techniques to enhance signal quality.

35. The base station of claim 29, wherein the base station processing unit is further configured to communicate to the UE information to assist the UE in specifying the UE Rx EA.

36. The base station of claim 29, where said communicate to the UE information from the base station holds UE Rx EA candidate options list.

37. The base station of claim 29, wherein the control unit is further configured to send an indication to the UE about the selected UE Rx EA candidates for DL reception.

38. The base station of claim 29, wherein the control unit selects the UE Rx EA based on at least one of signal-to-interference-plus-noise ratio (SINR), channel feedback, and UE capabilities.

39. The base station of claim 29, wherein the transmitted UL signals for channel estimation utilize reference signals, specifically Sounding Reference Signals (SRS).

40. The base station of claim 29, wherein the UE facilitates reciprocity-based DL channel estimation via its UL transmission when the number of specified UE Rx EAs exceeds the number of its Tx EAs, wherein said estimate DL channel response is making use of UL transmission that is segmented into multiple parts, each part holding one or more ports, and the parts are chosen for transmission one after the other.

41. The base station of claim 29, wherein the DL precoder is designed to minimize interference and maximize signal quality.

42. A User Equipment (UE) device for enhancing Downlink (DL) Reciprocity-based MU-MIMO performance in a wireless communication system, comprising:
a communication interface configured to receive DL signals from a base station to facilitate DL Reciprocity-based MU-MIMO performance improvement;
a memory unit configured to store instructions that, when executed by a processing unit, cause the UE device to:
specify at least one UE Rx EA (Effective Antenna) candidate;
transmit UL signals to facilitate reciprocity-based DL channel estimation by the base station, wherein the transmission is performed via the UE Rx EA candidates;
select at least one UE Rx EA candidate for DL decoding;
decode DL transmission data using the selected UE Rx EA(s); and
a control unit configured to control operations of the communication interface, processing unit, and memory unit according to the instructions stored in the memory unit, and wherein the UE device is adapted to perform operations to enhance Reciprocity-based MU-MIMO performance in the wireless communication system.

43. The UE device of claim 42, further comprising receiving an indication from the base station regarding selected UE EAs candidates for DL reception.

44. The UE device of claim 42, wherein the communication interface is further configured to receive information from the base station to assist in specifying the UE Rx EA.

45. The UE device of claim 44, wherein said receive information from base station holds UE Rx EA candidate options list.

46. The UE device of claim 42, wherein the instructions stored in the memory unit further cause the UE to specify the UE Rx EA candidate based on at least one of: information received from the base station, estimated DL channel response, past accumulated information or knowledge at UE, random selection, predefined selection, received signal quality, interference level, user mobility status, and historical performance data.

47. The UE device of claim 42, wherein the UL signals for channel estimation transmitted to the base station utilize reference signals, notably Sounding Reference Signals (SRS).

48. The UE device of claim 42, wherein the device facilitates reciprocity-based DL channel estimation via its UL transmission when the number of specified UE Rx EAs is greater than the number of its Tx EAs, wherein the UL SRS transmission is segmented into multiple chunks, each chunk holding one or more ports, and the chunks are selected for transmission one after the other.

49. The User Equipment device of claim 42, wherein specifying the at least one UE Rx EA candidate involves constructing a set based on multi-criterion optimization of uplink and downlink cost functions and their associated constraints.

50. The User Equipment device of claim 42, wherein the UE Rx EA candidates are dynamically adjusted based on changing wireless environment conditions.

51. A method for enhancing Downlink (DL) Reciprocity-based MU-MIMO performance in a User Equipment (UE), comprising the steps of:
specifying at least one UE Rx EA (Effective Antenna) candidate;
transmitting UL signals from the UE to facilitate reciprocity-based DL channel estimation by a base station, wherein the transmission is carried out via said specified at least one UE Rx EA;
select at least one UE Rx EA candidate for DL decoding; and
decoding DL transmission data at the UE using the selected UE Rx EA(s).

52. The method of claim 51, further comprising receiving an indication from the base station regarding selected UE EAs and utilizing said indication for DL reception.

53. The method of claim 51, further comprising the step of receiving information from the base station to assist in specifying the UE Rx EA.

54. The method of claim 53, wherein said receiving information from the base station holds UE Rx EA candidate options list.

55. The method of claim 51, wherein the specification of at least one UE Rx EA candidate is based on at least one of: information received from the base station, estimated DL channel response, past accumulated information or knowledge at UE, random selection, predefined selection, received signal quality, interference level, user mobility status and historical performance data.

56. The method of claim 51, wherein the transmitted UL signals for channel estimation utilize reference signals, notably Sounding Reference Signals (SRS).

57. The method of claim 51, wherein the UE facilitates reciprocity-based DL channel estimation via its UL SRS transmission when the number of specified UE Rx EAs exceeds the number of its Tx EAs, wherein the UL transmission is segmented into multiple chunks, each chunk holding one or more ports, and the chunks are chosen for transmission one after the other.

58. The method of claim 51, wherein specifying the at least one UE Rx EA candidate comprises constructing a set resulting from multi-criterion optimization of uplink and downlink cost functions and their associated constraints.

59. The method of claim 51, wherein the UE Rx EA candidates and the UE Rx EA candidate numbers are dynamically adjusted based on changing wireless environment conditions.
